(19) United States
(12) Patent Application Publication
(10) Pub. No.: US 2011/0047148 A1
(43) Pub. Date: Feb. 24, 2011

(54) INFORMATION NERVOUS SYSTEM

(76) Inventor: Nosa Omoigui, Redmond, WA (US)

Correspondence Address: BLACK LOWE & GRAHAM, PLLC, 701 FIFTH AVENUE, SUITE 4800, SEATTLE, WA, 98104, US

(21) Appl. No.: 12/748,121

(22) Filed: Mar. 26, 2010

Related U.S. Application Data
(63) Continuation of application No. 11/829,880, filed on Jul. 27, 2007, now abandoned.
(60) Provisional application No. 60/820,606, filed on Jul. 27, 2006.

(51) Int. Cl. G06F 17/30

(52) U.S. Cl. 707/723; 707/741; 707/739; 707/E17.002; 707/E17.09; 707/E17.014

(57) ABSTRACT

A semantically integrated knowledge retrieval, management, delivery and presentation system.

### PRIORITY CLAIM

This application is a continuation of U.S. patent application Ser. No. 11/829,880 filed Jul. 27, 2007 which claims priority to U.S. Provisional Patent Application No. 60/820,606 filed Jul. 27, 2006. This application also claims priority to U.S. Provisional Patent Application No. 60/681,892 filed May 16, 2005. U.S. patent application Ser. No. 11/127,021 filed May 10, 2005; which application claims priority to U.S. Provisional Application Ser. Nos. 60/569,663 (Attorney Docket No. NERV-1-1007) and/or U.S. Provisional Application Ser. No. 60/569,665 (Attorney Docket No. NERV-1-1008).

This application claims priority to U.S. application Ser. No. 10/179,651 (Attorney Docket No. FORE-1-1001) filed Jun. 24, 2002, which application claims priority to U.S. Provisional Application No. 60/360,610 (Attorney Docket No. NERV-1-1003) filed Feb. 28, 2002 and/or to U.S. Provisional Application No. 60/300,385 (Attorney Docket No. FORE-1-1002) filed Jun. 22, 2001. This application also claims priority to U.S. Provisional Application No. 60/447,736 (Attorney Docket No. NERV-1-1004) filed Feb. 14, 2003. This application also claims priority to PCT/US02/20249 (Attorney Docket No. FORE-11-1001) filed Jun. 24, 2002.

This application claims priority to U.S. application Ser. No. 10/781,053 (Attorney Docket No. NERV-1-1006) filed Feb. 17, 2004, which application is a Continuation-In-Part of U.S. application Ser. No. 10/179,651 filed Jun. 24, 2002, which claims priority to U.S. Provisional Application No. 60/360,610 filed Feb. 28, 2002 and/or to U.S. Provisional Application No. 60/300,385 filed Jun. 22, 2001. This application also claims priority to U.S. Provisional Application No. 60/447,736 filed Feb. 14, 2003. This application also claims priority to PCT/US02/20249 filed Jun. 24, 2002. This application also claims priority to PCT/US2004/004380 (Attorney Ref. No. NERV-11-1012) and/or U.S. application Ser. No. 10/779,533 (Attorney Ref. No. NERV-1-1005), both filed Feb. 14, 2004.

This application claims priority to PCT/US04/004674 (Attorney Docket No. NERV-11-1013) filed Feb. 14, 2004, which application is a Continuation-In-Part of U.S. application Ser. No. 10/179,651 filed Jun. 24, 2002, which claims priority to U.S. Provisional Application No. 60/360,610 filed Feb. 28, 2002 and/or to U.S. Provisional Application No. 60/300,385 filed Jun. 22, 2001. This application also claims priority to U.S. Provisional Application No. 60/447,736 filed Feb. 14, 2003. This application also claims priority to PCT/US02/20249 filed Jun. 24, 2002. This application also claims priority to PCT/US2004/004380 (Attorney Ref. No. NERV-11-1012) and/or U.S. application Ser. No. 10/779,533 (Attorney Ref. No. NERV-1-1005), both filed Feb. 14, 2004.

All of the foregoing applications are hereby incorporated by reference in their entirety as if fully set forth herein.

### COPYRIGHT NOTICE

This disclosure is protected under United States and/or International Copyright Laws. © 2002-2007 Nosa Omoigui. All Rights Reserved. A portion of the disclosure of this patent document contains material which is subject to copyright protection. The copyright owner has no objection to the facsimile reproduction by anyone of the patent document or the patent disclosure, as it appears in the Patent and/or Trademark Office patent file or records, but otherwise reserves all copyright rights whatsoever.

### BACKGROUND OF THE INVENTION

1. Field of the Invention

This invention relates generally to computers and, more specifically, to information management and/or research systems.

2. Background of the Invention

The general background to this invention is described in commonly owned co-pending parent applications (including U.S. application Ser. No. 11/505,261 filed Aug. 15, 2006, which is a continuation of U.S. application Ser. No. 10/179,651 filed Jun. 24, 2002, and all the applications listed above), which are all incorporated by reference herein.

### BRIEF DESCRIPTION OF THE DRAWINGS

Preferred and alternative embodiments of the present invention are described in detail below with reference to the following drawings.

FIG. 1 is an Ontology Objects Table Data and Index Model according to an embodiment of the invention;

FIG. 2 is an Ontology Semantic Links Table Data and Index Model according to an embodiment of the invention;

FIGS. 3-6 are screenshots illustrating principles of at least one embodiment of the invention;

FIG. 7 is a Table Showing Semantic Search Qualifiers and Corresponding Predicates according to an embodiment of the invention;

FIG. 8 is a screenshot illustrating principles of at least one embodiment of the invention; and

FIGS. 9-12 are screenshots illustrating principles of at least one embodiment of the invention.

### DETAILED DESCRIPTION OF THE PREFERRED EMBODIMENT

There will be debates, questions, etc. amongst users of the Information Nervous System on the appropriate queries to ask given the intent of the users. There might be a tendency to assume that this is a “problem,” and that the user should immediately be able to determine the right query given his/her intent. This is not necessarily a problem, but on the contrary can be an advantageous reflection of a natural and/or “Darwinian” process of context selection.

Intent and context are “curvy” and could have an arbitrary number of “geometric forms.” Indeed, it is great to see healthy debates and conversations on what the “right query” is, for a given user's intent. Part of this has to do with users having to become more familiar with the system. However, there will always be competing representations of semantic intent. This IS natural and healthy.

In a previously-filed commonly owned application, there was described what were called “entities.” Entities can include digital representations of abstract, personalized context. There may be competing entities within a community of knowledge. In one embodiment, users create and share entities INDEPENDENT of knowledge sources. In one scenario, an Entity Market could develop where domain experts could get bragging rights for creating and sharing the best entities in a given context. Human librarians could focus on creating and sharing the best entities for their organizations, based on their knowledge of ongoing projects and researchers' intent. Entities could even be shared across organizational boundaries by independent domain experts.

In one embodiment, users can be able to save and email entities to each other. The best entities will win. Again, this is natural.

In one embodiment, a user can be able to open an entity (sent, say, via email) in the Librarian and then drag and drop that entity to a Knowledge Community like Medline. Again, the entity is INDEPENDENT of the knowledge source. The entity could be applied to ANY knowledge source in ANY profile. With entities, context (and NOT content) is important.

In one embodiment, example of entities that would map to recent “debates on context” are:

1. HIV Infection (CRISP) and Immunologic Assay and Test (CRISP)

2. Plasmodium Falciparum (MeSH) AND Polymerase Chain Reaction (MeSH) AND (“diagnosis of malaria” OR “malaria diagnosis”)

Semantic stemming in the Knowledge Integration Service (KIS): In one embodiment, this allows the user to easily specify a qualified keyword that the KIS can interpret semantically. This can significantly aid usability, especially for those users that might not care to browse the ontologies, and for access from the simple Web UI. In one embodiment, the query, “Find all chemicals or chemical leads relevant to bone diseases and available for licensing” can now be specified simply as:

*:chemical “*:bone diseases” licensing

Or

*:chemical AND “*:bone diseases” AND licensing

The following rules may be used in various embodiments of the invention to achieve semantic stemming. Each of the rules may be practiced independently of the others or in combination with one or more rules. Furthermore, the rules themselves may be altered, reduced, or augmented with various steps as may be necessary.

1. In one embodiment, the KIS preferably maps *: to ALL supported ontologies and intelligently generates a semantic query (alternatively, the user can specify an ontology name to restrict the semantic interpretation to a specific ontology□ e.g., “MeSH:bone diseases”). This implementation turned out to be non-trivial because the KIS smartly prunes the query in order to guarantee fast performance. In one embodiment, the following pruning rules may be employed.

A. Map the keyword to categories by calling the Ontology Lookup Manager (OLM). The OLM caches the ontologies that the KIS may be subscribed to (via KDSes). The ontologies may be zipped by the KDS and/or exposed via [HTTP] URLs. The KIS then auto-downloads the ontologies as KDSes may be added to KCs on the KIS. The KIS also periodically checks if the ontologies have been updated. If they have, the KIS re-caches the ontologies. When an ontology has been downloaded, it may be then indexed into a local Ontology Object Model (OOM). The data model may be described in detail in the section titled “Semantic Stemming Processor Data and Index Model” below. The indexing may be transacted. Before an ontology may be indexed, the KIS sets a flag and serializes it to disk. This flag indicates that the ontology may be being indexed. Once the indexing is complete, the flag may be reset (to 0/FALSE). If the KIS is stopped or goes down while the indexing is in progress, the KIS (on restart) can detect that the flag is set (TRUE). The KIS can then re-index the ontology. This ensures that an incompletely indexed ontology isn't left in the system. In one embodiment, indexed ontologies may be left in the KIS and aren't deleted even when KCs are deleted—for performance reasons (since ontology indexing could take a while).

B. If at least one ontology for a KC is still being indexed into the OOM and a semantic query comes in to the KIS (needing semantic stemming), the KIS uses the KDS for ontology lookup. In such a case, the fuzzy mapping steps below may be employed. Else, the KIS employs the OLM, which invokes a semantic query on the Ontology Table(s) referred to by the semantic query. This first semantic query may get the categories from the semantic keywords (semantic wildcards). If there are multiple ontologies, a batched query can be used to increase performance (across multiple ontology tables in the OOM).

C. The modified time of ontologies at the KDS may be the modified time of the ontology file itself and not of the ontology metadata file; this way, if only the ontology XML file may be updated, that would be enough to trigger a KIS ontology-cache update.

D. For all returned categories (which could include many irrelevant categories because of poor document set analysis algorithms using context-less Latent Semantic Indexing or similar techniques), prune the list by checking for categories matching the qualified concept name (passed by the user)—when fuzzy mapping with the KDS may be employed

E. If there are still no categories, perform a fuzzy string compare (e.g., bacterium □ bacteria)—when fuzzy mapping with the KDS may be employed

F. If there are still no categories, add all the returned categories just to be safe—perhaps only when fuzzy mapping with the KDS may be employed

G. If there are still no categories, add a non-semantic concept corresponding to the passed concept name. The KIS defaults to a non-semantic filter if the specified filter cannot be semantically interpreted. This allows the user to be lazy by specifying the “*:” with the assurance that keywords may be used as a last resort.

H. Add the pruned categories to a local cache for super-fast lookup. The cache may be guarded by a reader-writer lock since the cache may be a shared resource. This ensures cache coherency without imposing a performance penalty with multiple simultaneous queries.

1. The cache may be pruned after 10,000 entries using FIFO logic.

2. In one embodiment, the stemmer intelligently picks candidates on a per ontology basis—when fuzzy mapping with the KDS may be employed. This way, selecting one good candidate from one ontology does not preclude the selection of other good candidates from other ontologies—even with a direct (non-fuzzy) match with one ontology.

### Example

*:chemical would map to chemical (CRISP) and/or Drugs and Chemicals (Cancer). Ditto for *:chemicals.

3. When fuzzy mapping is employed, in one embodiment, more fuzzy logic can be added to map terms in the semantic stemmer to close equivalents—e.g., *:Calcium Channel-Calcium Channel Inhibitor Activity. In one embodiment, this errs on the conservative side (supersets may be favored more than subsets; subsets may require the same number of terms to qualify as candidates). In any event, even if the fuzzy logic results in false positives, the model still handles this and “bails itself out” (the fuzzy logic, not unlike the ontology imperfections, may be a form of uncertainty). The eventual filters soften the impact of this uncertainty.

4. When fuzzy mapping is employed, added more predicate logic to correctly interpret complex queries that have field qualifiers. The KIS can infer the union of predicates for complex queries that have a combination of different qualifiers. This may be a semantic approximation in order to guarantee fast graph traversal. However, by restricting the predicate set to the union set (as opposed to all predicates), this significantly increases precision for these query types.

5. Example: Find all research on Heart or Bone Diseases published by Merck or published in 2005:

Dossier on (“*:Heart Diseases” OR “*:Bone Diseases”) AND (affil:Merck OR pubYear:2005)

6. The KIS can add a default concept filter check for ontology or cross-ontology qualified keywords (e.g., “*:bone diseases”). This addition may be only done for rank bucket 0 and/or for All Bets or Random Bets—for non-semantic sub-queries. This offers high precision even with ontology-qualified keywords and/or for semantic knowledge types like Best Bets or Breaking News.

7. When fuzzy mapping is employed, added more smarts to the KIS semantic stemmer. If the stemmer doesn't find initial candidates, it preferably carefully prunes the large (and/or often false-positive laden—due to context-less document analysis) category list from the KDS. It does this by eliding parent paths for all paths—ensuring that no included path also has an ancestor included. This heuristic works very well, especially since the KIS does its own semantic and/or context-sensitive inference (meaning the stemmer doesn't have to try to be too clever).

### Example

Find all recent press releases or product announcements on infectious polyneuritis:

Dossier on “*:infectious polyneuritis”

This preferably returns results on polyneuritis and on the Guillain-Barre Syndrome, which IS also known as infectious polyneuritis.

8. The semantic stemmer preferably recognizes ontology name aliases.

So you can preferably have Dossier on G0-Bio:Apoptosis

Alias names for all our current ontologies are available. However, even if the alias name is not present, the KIS tries to infer the ontology name by performing a direct or fuzzy match. So Cancer:Kinase or NCI:Kinase would both work and both map to Cancer (NCI).

9. The KIS semantic stemmer can dynamically add a non-semantic concept filter for an ontology qualified concept IF the rank bucket is 0 or if the concept could not be semantically interpreted. This is beautiful because it works for all cases: if the concept could not be interpreted, the non-semantic approximation may be used; if the concept was interpreted and/or the context is semantic (e.g., Best Bets or Breaking News), the non-semantic concept may be not added so as not to pollute the results (since the concept has already been interpreted); if, on the other hand, the rank bucket is 0, the semantics don't matter so adding the concept is a good thing anyway (it increases recall without imposing a cost on precision), even if the concept has already been semantically interpreted.

1. In one embodiment, a method to the KIS Web Service Interface for the Web UI integration. The KIS may be passed a text string (including Booleans) which it can then map to a semantic query.

2. In one embodiment, the KIS can automatically specify the “since” parameter to the KIS Data Connector (if it detects this) to optimize the incremental indexing path to minimize the number of redundant queries during incremental indexing (since there are much more read-write contention—since it may be a real-time service).

3. In one embodiment, the KIS may use the system thread-pool and/or EACH KC runtime object can have its own semaphore. This ensures that the KCs don't overwork the KDSes yet increases concurrency by allowing multiple KCs to index as fast as possible simultaneously.

4. In one embodiment, the central KIS runtime manager holds/increments a work reference count on each document sourced from each connector that may be currently indexing (it releases/decrements it once it is done indexing the document). This fixes a problem where a KC connector would quickly “find” an RSS file and think it was done, even while the items within the RSS file were still being processed and/or indexed.

5. In one embodiment, the KIS supports broad time-sensitivity settings

a. Every two months

b. Every three months

6. In one embodiment, the KIS can map extended characters to English-variants. For instance, the Guillain-Barré Syndrome can be mapped to Guillain-Barre Syndrome.

In one embodiment, Semantic Wildcards may be also integrated with Deep Info. The user may be able to specify a request including (but not limited to) semantic wildcards and/or then navigate the virtual knowledge space using the request as context. The KIS returns category paths to the semantic client which can then be visualized in Deep Info (not unlike Category Discovery). The user may be then able to navigate the hierarchies and/or continue to navigate Deep Info from there. The following are examples of various embodiments of the invention. They may be practiced independently or in combination and/or may be limited or augmented with steps as may be necessary.
The categories may be visualized in the Deep Info console. And then the tree can be directly invoked by the user to launch a semantic query off a related category once the user discovers a category from his/her launch point (returned categories can be visualized differently from parent categories—perhaps in a different font/color). This could be a profile, keywords, document, entity, etc. In this case, it may be the request itself.
There may be a Request Deep Info, Profile Deep Info, and/or Application Deep Info—corresponding to different default launch points (in all cases, some Deep Info elements—like Categories in the News, etc.—can always be available). In other cases, the user can type in keywords in the Deep Info pane to “semantically explore” the keywords without explicitly launching a request.
Another launch point may be the Clipboard—the Deep Info console can have a Clipboard Launch Point (if there is something on the clipboard) for whatever may be on the clipboard. This is very powerful as it would the user to copy anything to the clipboard (text, chemical images, document, etc.), go to the Deep Info and/or then browse/explore without actually launching a request.

Some Deep Info metadata (like categories) can be returned as part of the SRML header (they may be request-specific but result-independent).

The KIS can preferably handle virtually any kind of semantic query that users might want to throw at it (Drag and Drop and/or entities can provide even more power).

Find recent research by Pfizer or Novartis on the impact of cell surface receptors or enzyme inhibitors on heart or kidney diseases

We can preferably handle this query as follows:

Dossier on (Pfizer or Novartis) AND (“*:Cell Surface Receptors” OR “*:Enzyme Inhibitors”) AND (“*:Heart Diseases” OR “*:Kidney Diseases”)

An example of the semantically stemmed and/or generated sub-queries is shown below.

Generated Sub-Query #1
SELECT TOP 120 *
FROM [DOCUMENTS_EC8E8136-A928-4E8F-BFD4-6832501EAAD0]

doc INNER JOIN

[SEMANTICLINKS_EC8E8136-A928-4E8F-BFD4-

6832501EAAD0] sem0 ON doc.ObjectID = sem0.SubjectID AND doc.BestBetHint = 1 AND

sem0.BestBetHint = 1 AND sem0.PredicateTypeID IN (13, 12,

11, 10, 9, 8, 7, 6, 5, 2, 1) AND sem0.ObjectID IN

(SELECT ObjectID

| | |
|---|---|
| FROM | [OBJECTS_EC8E8136-A928-4E8F-BFD4- |

6832501EAAD0]

WHERE (Uri IN

(‘NERV://NOVARTIS?TYPE=CONCEPT’, ‘NERV://PFIZER?TYPE=CONCEPT’))) INNER
JOIN

[SEMANTICLINKS_EC8E8136-A928-4E8F-BFD4-

6832501EAAD0] sem1 ON doc.ObjectID = sem1.SubjectID AND doc.BestBetHint = 1 AND

sem1.BestBetHint = 1 AND sem1.PredicateTypeID IN (13, 12,

11, 10, 9, 8, 7, 6, 5, 4, 3, 2, 1) AND sem1.ObjectID IN

(SELECT ObjectID

| | |
|---|---|
| FROM | [OBJECTS_EC8E8136-A928-4E8F-BFD4- |

6832501EAAD0]

WHERE (Uri IN (‘NERV://1FFEB1D0-8AFD-475D-

9C4F-16BBD3AA82A7?TYPE=CATEGORY&PATH=CARDIOVASCULAR
DISEASES/HEART DISEASES’,

‘NERV://75CDAA80-A05F-4BFA-8D9C-

E1F9DB2A6F4C?TYPE=CATEGORY&PATH=FINDINGS AND DISORDERS
KIND/DISEASES DISORDERS AND FINDINGS/DISEASES AND
DISORDERS/DISORDER BY SITE/RESPIRATORY AND THORACIC
DISORDER/THORACIC DISORDER/HEART DISEASE’,

‘NERV://75CDAA80-A05F-4BFA-8D9C-

E1F9DB2A6F4C?TYPE=CATEGORY&PATH=FINDINGS AND DISORDERS
KIND/DISEASES DISORDERS AND FINDINGS/DISEASES AND
DISORDERS/DISORDER BY SITE/CARDIOVASCULAR DISORDER/HEART DISEASE’,

‘NERV://1FFEB1D0-8AFD-475D-9C4F-

16BBD3AA82A7?TYPE=CATEGORY&PATH=UROLOGIC AND MALE GENITAL
DISEASES/UROLOGIC DISEASES/KIDNEY DISEASES’)))

INNER JOIN
[SEMANTICLINKS_EC8E8136-A928-4E8F-BFD4-

6832501EAAD0] sem2 ON doc.ObjectID = sem2.SubjectID AND doc.BestBetHint = 1 AND

sem2.BestBetHint = 1 AND sem2.PredicateTypeID IN (13, 12,

11, 10, 9, 8, 7, 6, 5, 4, 3, 2, 1) AND sem2.ObjectID IN

(SELECT ObjectID

| | |
|---|---|
| FROM | [OBJECTS_EC8E8136-A928-4E8F-BFD4- |

6832501EAAD0]

WHERE (Uri IN (‘NERV://C2573970-E4F6-4454-9A12-

5CEA7D7E1250?TYPE=CATEGORY&PATH=CHEMICAL/DRUG AND
AGENT/INHIBITOR AND ANTAGONIST/ENZYME INHIBITOR’,

‘NERV://1FFEB1D0-8AFD-475D-9C4F-

16BBD3AA82A7?TYPE=CATEGORY&PATH=CHEMICAL ACTIONS AND
USES/PHARMACOLOGIC ACTIONS/MOLECULAR MECHANISMS OF
ACTION/ENZYME INHIBITORS',

‘NERV://75CDAA80-A05F-4BFA-8D9C-

E1F9DB2A6F4C?TYPE=CATEGORY&PATH=CHEMICALS AND DRUGS KIND/DRUGS
AND CHEMICALS/DRUGS AND CHEMICALS FUNCTIONAL
CLASSIFICATION/PHARMACOLOGIC SUBSTANCE/ENZYME INHIBITOR’,

‘NERV://75CDAA80-A05F-4BFA-8D9C-

E1F9DB2A6F4C?TYPE=CATEGORY&PATH=GENE PRODUCT KIND/GENE
PRODUCT/PROTEIN/PROTEIN ORGANIZED BY FUNCTION/LIGAND BINDING
PROTEIN/RECEPTOR/CELL SURFACE RECEPTOR’)))

• Semantic Client highlights preferred ontology-qualified prefix tags

In one embodiment, Ontology qualified or multi-ontology qualified search terms and the Librarian can semantically highlight relevant terms. So for example, type in Dossier on “*:bone disease” and the semantic client can do the smart thing. This was non-trivial and has some pieces that need to be noted in the docs:

In one embodiment, ontology-qualified terms may be dynamically interpreted based on the current profile, the semantic client maps the terms (e.g., “*:bone disease”) to the ontologies for the request profile. It gets tricky shortly thereafter. For multi-ontology mapping (prefixed with “*:”), the semantic client figures out the ontologies for the request profile and/or add semantic highlight terms for each of these ontologies. However, going through multiple ontologies has an impact on performance. Furthermore, the user could (in the limit) have a profile with tens of KCs each of which has several different ontologies. As such, a more pragmatic, fuzzy algorithm was called for. The following are various embodiments of the invention that may be practiced independently or in combination and/or may be reduced or augmented or altered with steps as may be necessary.

a) The Librarian first starts a timer to time the mapping process. This may be configurable and/or can be switched off to have no timer.

b) The Librarian then tries all the ontologies in the request profile in the order of ontology size. This ensures that it flies through smaller ontologies.

c) If the ontology returns in less than a second, the timer (if available) may be reset. This ensures that many small ontologies don't preclude the generation of terms from larger ontologies that await downstream in time.

d) Once the Librarian finds an ontology that has the semantic terms, it stops. This may be a good trade-off because the alternative may be to greedily check all ontologies for the terms. This isn't practical and/or wouldn't buy much because there may be a fair chance that the ontologies have good terms for the desired concept (if they have the concept at all). In other words, the likelihood is that an ontology either has good terms for a concept or doesn't support the concept, period.

e) The Librarian continues to hunt for semantic terms with the remaining ontologies until the timer expires. Currently, there may be a timeout of 10 seconds.

f) The mapping process using XPath to find every descendant of every category that has a hook corresponding to the desired concept. This entailed loading the XML document, finding all the hooks with the concept name, cloning the iterator, navigating to the parent category, and/or then selecting all the descendants of the parent category.

g) When the Presenter attempts to ask for the highlight hit list, the semantic runtime client preferably waits for the hit generation for 10 seconds (if configured to have a timer). This may be enough time for most queries but also prevents the system from locking up in case the user has a query with, say, 20, cross-ontology qualifiers (this could hang the system).

h) This algorithm may be stable and/or provides the user with a very high probability of always getting most or all the right terms (with “*:”) or all the right terms with specific categories or keywords, WITHOUT making the system vulnerable to hangs with, say, arbitrary queries with a profile with many arbitrary KCs.
Support parenthesized filters on categories

In one embodiment, the entire system (end-to-end) supports parenthesized category filters.
Semantic client correctly highlights hooks included in “NOT” predicates

In one embodiment, Dossier on Autoimmune Diseases AND NOT on Multiple Sclerosis excludes Multiple Sclerosis terms from the highlight list.
Semantic client to stop exploding complex search queries (KIS preferably handles this)

In one embodiment, the semantic client attempts to explode complex queries. The KIS handles all complex Boolean logic so the Librarian doesn't have to do this.
Highlighting with categories that have single or double quotes)

In one embodiment, the XPath query uses double-quotes (consistent with the XPath spec).
Export and/or import speed up with ontology downloads and hit cache included

In one embodiment, the semantic client excludes ontology and/or highlighting hit cache state from import/export. The Librarian can regenerate the hit cache after an import.

Overview
In one embodiment, the KIS uses the system thread-pool and EACH KC runtime object preferably has its own semaphore. This ensures that the KCs don't overwork the KDSes yet increases concurrency by allowing multiple KCs to index as fast as possible simultaneously.
In one embodiment, the central KIS runtime manager holds/increments a work reference count on each document sourced from each connector that may be currently indexing (it releases/decrements it once it is done indexing the document).

Ads in news feeds can be problematic because they can affect the ability of the KIS to semantically filter and/or rank properly. For instance, some web pages contain several times (at times more than 5 times) as much ad content as the actual content for the article. Here is an example: [http]://www.npr.org/templates/story/story.php?storyId=4738304&sourceCode=RSS

In one embodiment, this problem may be addressed in the following manner:

1. Assume that all articles contain ads. The news connector can indicate this in the generated RSS. The KIS takes this as a signal not to follow the link (this is what currently happens for Medline). Due to the KIS' Adaptive Ranking algorithm, the KIS may be able to semantically rank on a relative basis so that the “best” descriptions can still be returned first. From looking at the metadata, the size distribution may be all over the map but is acceptable (there are many meaty descriptions). Optionally advantageously, the descriptions for the Life Sciences channel tend to be very meaty.

2. Implement a Safe List. The Safe List may be manually maintained initially. This can contain a list of publisher names that don't include ads. A good example is the Business-Wire which includes press releases. We can manually maintain the Safe List as part of our ASP value proposition. The News Connector can check the Safe List and/or if the publisher is deemed safe, can indicate to the KIS that it can safely index the entire document.

3. Automate the Safe List. A set of algorithms to attempt to automate the population and/or maintenance of the Safe List. This involves populating a Safe Candidate List, which can then be periodically scanned by humans. Humans can ultimately be responsible for what goes into the Safe List. The auto-population may be based on detecting those URLs that have “Printable Page” links. If these are detected, the connector can indicate to the KIS that it is to index the printable pages. These generally don't contain ads.

4. Content-cleansing uses heuristics, machine learning, and/or layout analysis to automatically detect whether a page has ads. If ads are detected, the service can then attempt to extract the subset of the document that may be the meat of the document (as text) and/or then indicate to the KIS (via RSS signaling) that the KIS is to index that document.

In one embodiment, a combination of all three processes can address the issue.

The following are rules that may be used in various embodiments of the invention. They may be practiced independently or in combination and/or may be altered as may be necessary.

Ad-Removal Rule #1

For every HTML page (I have code for this—a URL not in the HTML exclusion list or a URL that has a query [Uri uri=new Uri(url); if ((uri.Query !=String.Empty) && (uri.Query !=“?”))] . . . .

If the web page contains a link (walk the link list using SgmlReader, which converts HTML to XHTML—see last URL I emailed you; use XPath to walk the list) with any of the following titles (case-insensitive comparison):

1. “Text only”

2. “Text version”

3. “Text format”

4. “Text-only”

5. “Text-only version”

6. “Text-only format”

7. “Format for printing”

8. “Print this page”

9. “Printable Version”

10. “Printer Friendly”

11. “Printer-Friendly”

12. “Print”

13. “Print story”

14. “Print this story”

15. “Printer friendly format”

16. “Printer-friendly format”

17. “Printer friendly version”

18. “Printer-friendly version”

19. “Print this”

20. “Printable format”

21. “Print this article”

And if the link is not JavaScript (which launches the print dialog) . . . .

Add the linkToBeIndexed tag to the generated RSS and/or point it to the printable link.

Alternate embodiments also detect the “print” icon with the “print” tool tip (or any tool tip with text mapping to any of the above), and/or apply the same rule.

Ad-Removal Rule #2

Cache the stats on host names for which rule #1 works. Add the host names to a “safe list candidates” file. We then need to validate those candidates and/or add them to the safe list. You also add items to the safe list based on submissions from trusted people (e.g., within Nervana and/or Beta customers).

Ad-Removal Rule #3

Apply the current rules (per description length, etc□ since these also save network I/O

If the item is recommended for addition:

If the hostname for an item is in the safe list,
Add it as “follow” with the inserted linkToBeIndexed tag

Else

Run rule #1
If the item is a safe candidate

Add the host name to the “safe candidate list” file

(if it isn't there already - use a hash table for quick comparison)

Add it as “follow” with the inserted

linkToBeIndexed tag

Else

Add it as “nofollow”

Else

Add it as “nofollow”

As users/testers use the KCs, and/or if they see a pattern of content that don't contain ads, they can email the URL and/or the Publisher (via the Details Pane) to Nervana to add to the Safe List. Over time, this can accrete and/or can increase the recall of the system.

These ad removal and/or cleansing rules can also be employed at the semantic client during Dynamic Linking (e.g., Drag and Drop or Smart Copy and Paste). For example, if the user drags and drops a Web page, the cleansing rules can first be invoked to generate text that does not contain ads. This may be done BEFORE the context extraction step. This ensures that ads are not semantically interpreted (unless so desired by the user—this can be a configurable setting).

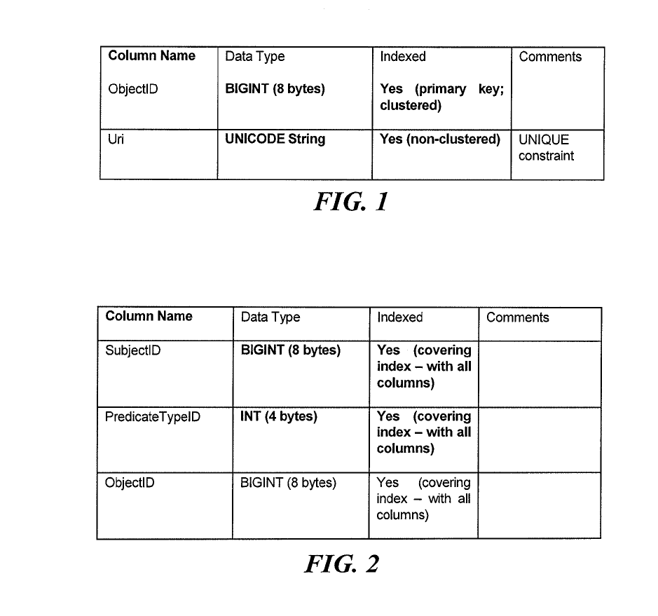

FIGS. 1 and 2 illustrate sample tables that may be present in various embodiments of the invention.

There may be also a composite index which is the primary key (thereby making it clustered, thereby facilitating fast joins off the SemanticLinks table since the database query processor may be able the fetch the semantic link rows without requiring a bookmark lookup) and which includes the following columns:

1. SubjectID

2. PredicateTypeID

3. ObjectID

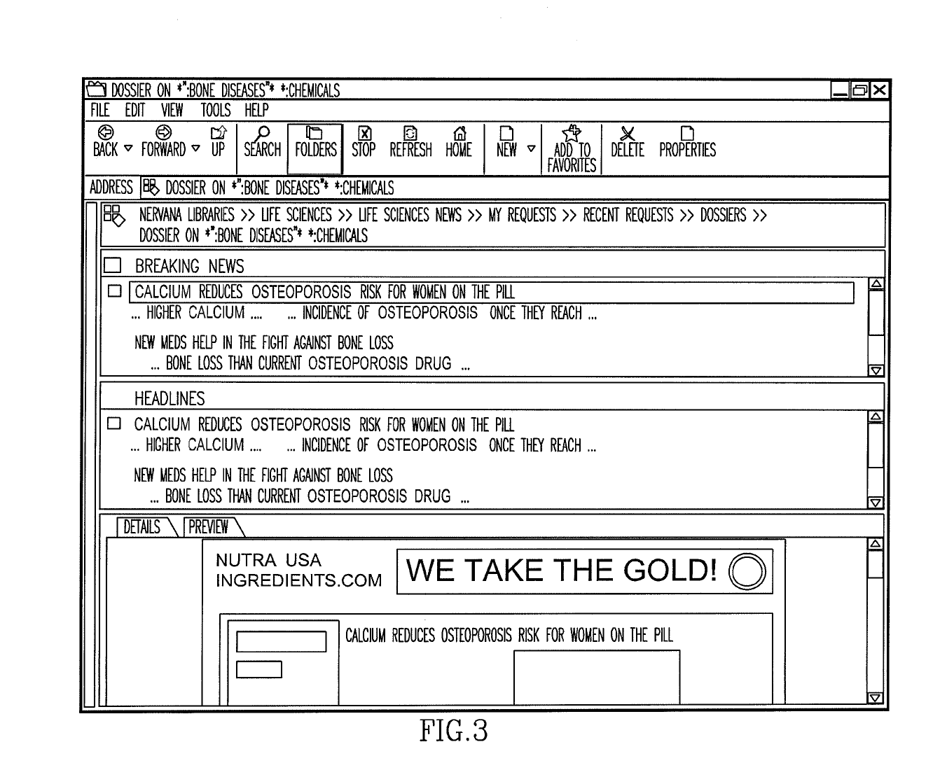

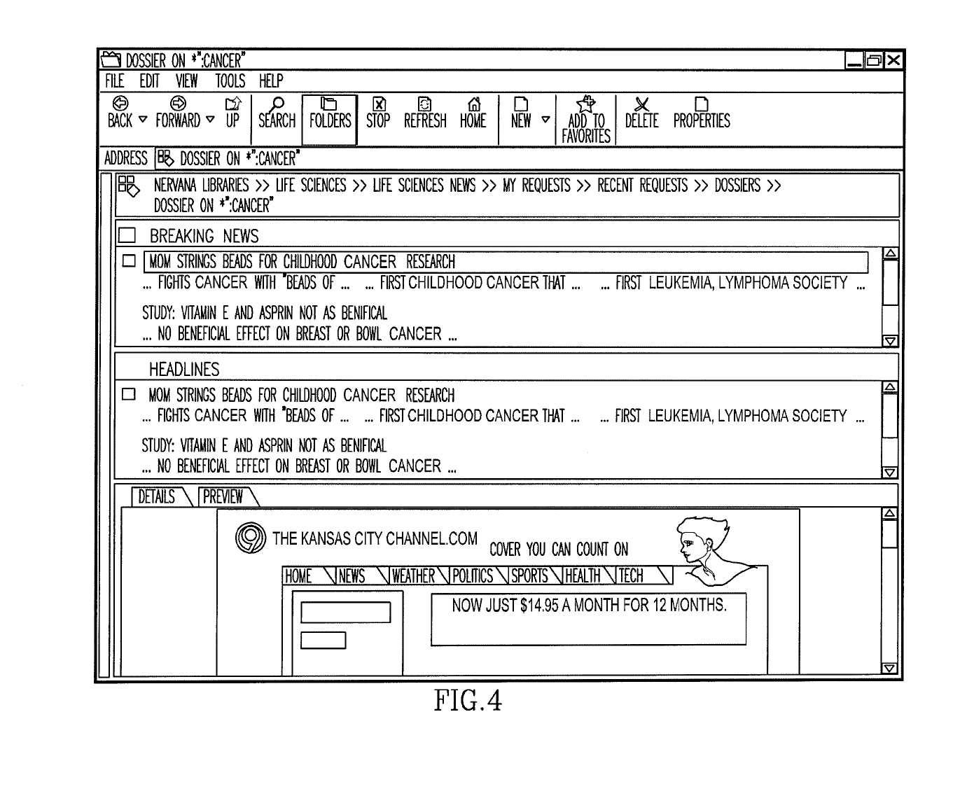

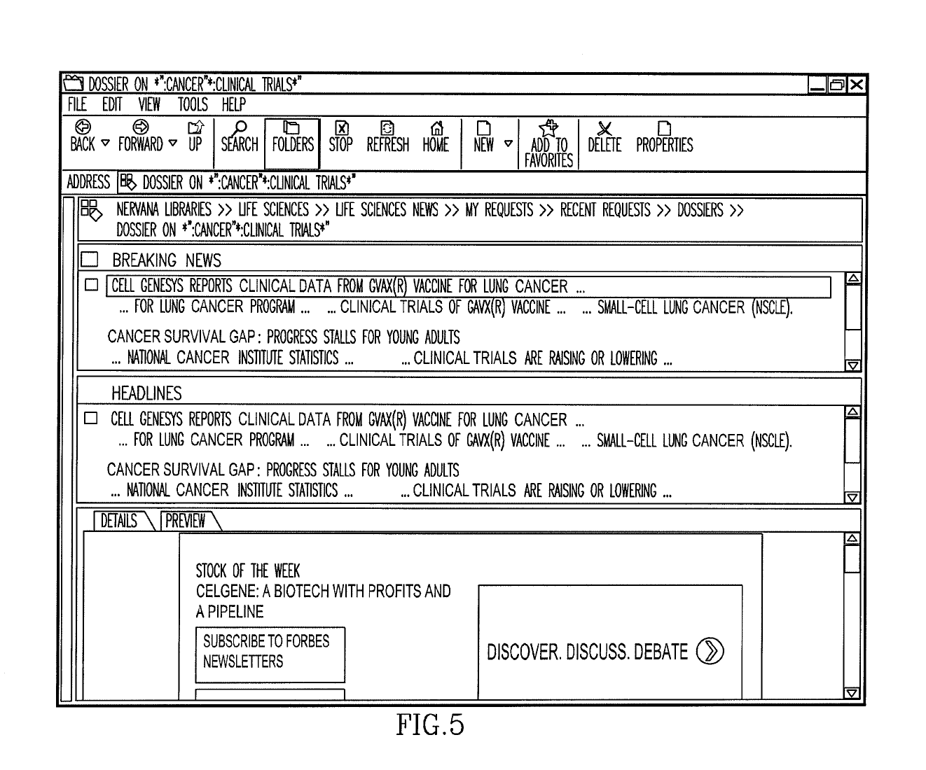

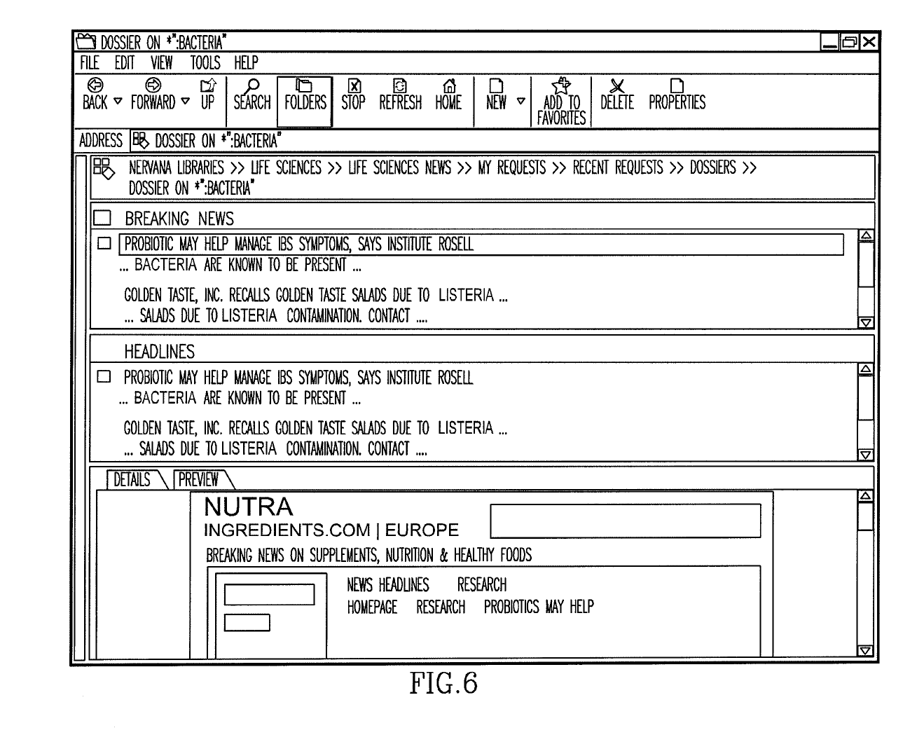

FIGS. 3-6 illustrate examples of various embodiments of the invention, that are operable, for example, to:

1. Find me Breaking News on Chemical Compounds Relevant to Bone Diseases—Dossier on “*:bone diseases” chemical

2. Find me Breaking News on Cancer—Dossier on *:cancer

3. Find me Breaking News on Cancer-Related Clinical Trials—Dossier on “*:clinical trials”*:cancer

4. Find me Breaking News on Bacteria—Dossier on *:bacteria

In one embodiment, the Life Sciences News KC can periodically ask the General News KC (during its real-time indexing process) for Breaking News on *:Health OR “*:Health Care” OR “*:Medical Personnel” OR *:Drugs OR “*:Pharmaceutical Industry” OR *:Pharmacology OR “*:Medical Practice”

This way, we can have chained Breaking News.

In one embodiment, a KC was populated based on editorial rules, based on tags provided by our news provider, to determine which sources and/or articles may be Life-Sciences-related.

When there is Life-Sciences-related content in General News (or other combination) that needs to be indexed in Life-Sciences News, this can be accomplished using KIS-Chaining The Life Sciences (LS) News KC can ALSO point to the General News KIS via the preferred KIS RSS interface. The RSS can include a reference to *:Health OR “*:Health Care” OR “*:Medical Personnel” OR *:Drugs OR “*:Pharmaceutical Industry” OR *:Pharmacology OR “*:Medical Practice”

These come from the General Reference and Products & Services ontologies, which the General News KC may be indexed with.

The LS News KC can index the Health subset of the General Reference KC. This way, we use our own technology for domain-specific filtering.

Other vertical KCs (e.g., IT, Chemicals, etc.) can also employ the same approach to ensure they have the most relevant yet broad dataset to index. And that way, we don't rely too much on the tags that come from Moreover to figure out which articles may be Life-Sciences-related.

In one embodiment the approach described below may be set for the IT News KC and/or ALL Vertical KCs.

The approach can also be used to funnel (or tunnel, depending on your perspective) traffic from the General patents KC to the Life Sciences patents KC (and/or other vertical patents KCs in the future).

In one embodiment, we track the traffic for Breaking News for the following categories (ORed) from General News and/or compare that with the traffic on Breaking News on the Life Sciences KC.

We can then funnel content from the General News KC to the Life Sciences News KC via machine-to-machine KIS Chaining as described.

It is OK if these categories represent overly broad context. The Life Sciences News KC can still do its job and/or semantically filter and/or rank the articles according to its 6 Life Sciences ontologies. This may be akin to chaining perspectives and/or then performing “perspective switching and/or filtering” downstream.

Clinical Tests of Medical Procedures OR

Drugs OR

Forensic Medicine OR

Group Medical Practice (all contexts) OR

Health OR

Health Care OR

Health Insurance OR

Home Medical Tests OR

Medical Equipment OR

Medical Ethics OR

Medical Examiners OR

Medical Expense Deduction OR

Medical Malpractice OR

Medical Personnel OR

Medical Records OR

Medical Research OR

Medical Savings Accounts (all contexts) OR

Medical Schools OR

Medical Screening OR

Medical Supplies OR

Medical Technology OR

Medical Wastes OR

Pharmaceutical Industry OR

Pharmacology OR

Preventive Medicine OR

Sports Medicine OR

Telemedicine OR

Biological Clocks OR

Biological Diversity (all contexts) OR

Biology OR

Biologists OR

Biological and Chemical Weapons (all contexts) OR

Biotechnology OR

Agricultural Biotechnology OR

Genetics OR

Anatomy and Physiology OR

Animal Care OR

Animals OR

Aquatic Life OR

Births OR

Chemicals OR

Child Care OR

Child Development OR

Children and Youth OR

Cognition and Reasoning OR

Contamination OR

Death and Dying OR

Environment OR

Farming OR

Females OR

Flowers and Plants

Food

Food Processing Industry

Food Products

Food Service

Food Service Industry

Gardens and Gardening

Hazardous Substances

Hazards

Life

Life Cycles

Livestock Industry

Males

Membranes

Memory

Menstruation

Mental Disorders

Molecules

Nature

Organisms

Personal Relationships

Proteins

Psychiatry

Reproduction

Social Research

Zoology

Social Psychology

Sociology

Scientific Imaging

Ecologists

Sexes

Sexual Behavior

Sleep

Sleep Disorders

Speech

Stress

Urology

Waste Disposal

Waste Management Industry

Waste Materials

Water Treatment

Wildlife Management

Wildlife Observation

Wildlife Sanctuaries

Patent Search Techniques

Applicant hereby incorporates by reference the following: [http]://www.stn-international.de/training_center/patents/pat_for0602/prior_art_engineering.pdf

Search Question:

“Find patent and non-patent prior art for the use of dielectric materials in cellular telephone microwave filters”

Manual Prior Art Search Strategy:

Step 1: Quick search in COMPENDEX to identify relevant terminology

Step 2: Develop search strategy using COMPENDEX and INSPEC thesaurus terminology.

Step 3: Modify search terms for use in WPINDEX

Step 4: Identify appropriate IPCs and Manual Codes

Step 5: Explore Thesauri for Code definitions

Step 6: Refine strategy

Step 7: Identify LEXICON terms for a CAplus search

Step 8: Combine, de-duplicate, sort and display results

Which leads to this first pass search (assuming you happened to correctly identify all the relevant search terms from all the relevant sources above):

(Dielectrics OR Ceramic materials OR Dielectric materials) AND

(Mobile phones OR Telecommunications OR Handy OR Cellular phone OR Portable phone

OR Wireless communication OR Cordless communication OR Radiophone) AND (Microwave

OR High frequency OR High power OR High pulse OR High waveband)

and other combinations . . . no wonder it's so expensive and time consuming.

In one embodiment, this may be done with a powerful, natural semantic query:

Check out the Engineering ontology in the semantic client. It has everything needed for this query: “dielectric materials” AND “microwave filters” AND “cellular telephone systems”

The painful keyword search below may be replaced by a simple Nervana semantic search on an Engineering patents KC indexed with the Engineering ontology for

“*:dielectric materials” AND “*:cellular telephone” AND “*:microwave filters”

In addition, the Information Nervous System adds multi-dimensional semantic ranking which may be currently a manual (and almost impossible) task.

The following are sample queries used in various embodiments of the invention.

Find me News on chemical compounds relevant to the treatment of bone diseases:
Dossier on “*:bone diseases”*:chemicals

Find me News on chemical compounds relevant to the treatment of musculoskeletal or heart diseases:
Dossier on *:chemicals AND (“*:musculoskeletal diseases” OR “*:heart diseases”)

Find me News on autoimmune, cardiovascular, kidney, or muscular diseases:
Dossier on “*:autoimmune diseases” OR “*:cardiovascular diseases” OR “*:kidney diseases” OR “*:muscular diseases”

Find me latest News on work Pfizer, Novartis, or Aventis are doing in cardiovascular diseases:
Dossier on “*:cardiovascular diseases” AND (Pfizer or Novartis or Aventis)

Find me latest News on cell surface receptors relevant to all types of Cancer:
Dossier on “*:cell surface receptor”*:cancer

Find me latest News on enzyme inhibitors or monoclonal antibodies:
Dossier on “*:enzyme inhibitors” OR “*:monoclonal antibodies”

Find me latest News on genes that might cause mental disorders:
Dossier on *:genes “*:mental disorders”

Find me latest News on ALL protein kinase inhibitors or biomarkers but only in the context of cancer:
Dossier on “cancer: protein kinase inhibitors” OR cancer: biomarkers

Find me latest News on Cancer-related clinical trials:
Dossier on “*:clinical trials”*:cancer

Find me latest News on clinical trials on heart or muscle diseases:
Dossier on “*:clinical trials” AND (“*:heart diseases” OR “*:muscle diseases”)

I want to track news on the Gates Foundation's Grand Challenge titled “Develop a genetic strategy to deplete or incapacitate a disease-transmitting insect population”
Dossier on *:genetics *:diseases *:insects

I want to track news on the Gates Foundation's Grand Challenge titled “Develop a chemical strategy to deplete or incapacitate a disease-transmitting insect population”
Dossier on *:chemicals *:diseases *:insects

Find me research news highlighting the role of genetic susceptibility in pollution-related illnesses.
Dossier on *:genetics *:pollution *:diseases

1. Find research by Amgen or Genentech on chemical compounds used to treat autoimmune diseases:

Dossier on AutoImmune Diseases (MeSH) AND Chemical (CRISP) AND (Amgen OR Genentech) à this works today (another common example is to filter by year à e.g., (2004 or 2005))

2. Find research by Roche or Pfizer published in the past three years on the use of protein kinase or cyclooxygenase inhibitors to treat Lung or Breast Cancer:

Dossier on (“*:Protein Kinase Inhibitor” OR “*:cyclooxygenase inhibitor”) AND (“*:Lung Cancer” OR “*:Breast Cancer”) AND (Roche or Pfizer) AND (range:2003-2005)

Here is an alternative that can work across ALL unstructured data repositories:

Dossier on (“*:Protein Kinase Inhibitor” OR “*:COX Inhibitor”) AND (“*:Lung Cancer” OR “*:Breast Cancer”) AND (Roche or Pfizer) AND (range:2003-2005)

Here is a more specific alternative:

Dossier on (“*:Protein Kinase Inhibitor” OR “*:COX Inhibitor”) AND (“*:Lung Cancer” OR “*:Breast Cancer”) AND (affiliation: Roche or affiliation: Pfizer) AND (pubyear:2003-2005)

In one embodiment, *: may be a preferred and very powerful way for expressing semantic queries in Nervana and provides as close to natural-language queries as may be computationally possible.

In one embodiment, *: provides semantic stemming and semantic reasoning to INFER what terms MEAN IN A GIVEN CONTEXT IN A GIVEN PROFILE, NOT synonyms or other word forms of the terms.

In one embodiment, the Information Nervous System (read: The Nervana System) also semantically ranks results with *: queries IN THE CONTEXT of the desired terms/concepts. In the preferred embodiment, this may be NOT the same as mapping the query to a long Boolean query nor may it be the same as ranking the synonyms of the terms.

In one embodiment, a Dossier on “*:bone diseases” AND *:chemicals may be NOT mathematically equivalent to a Boolean search for every type of bone disease (ORed) AND every type of chemical (ORed) BECAUSE OF CONTEXT-SENSITIVE RANKING.

In one embodiment, to increase recall, the KIS (on indexing incoming content from news feeds and other sources) adds the following logic:

1. If you cannot extract the description and the metadata description may be empty, mark it as unsafe for follow. Then add the “safe” column to the composite constraint that includes Title and Accessible.

2. If a particle comes in with the same title as something you have already *attempted* to extract and the preferred one can be extracted, you replace the one that failed with the preferred one.

3. Mark [http]s URLs as unsafe to follow (preferably but optionally requiring subscription)

Logging Searches, Privacy, and Smarter Ontology Tools

In one embodiment, with privacy provisions, the KIS can *anonymously* log semantic searches and use those logs to improve our ontologies.

In one embodiment, actual searches are a great window to actual REAL-WORLD vocabularies being used—including typos and/or other word-forms that our ontologies might currently lack.

In one embodiment, this idea relates to an end-to-end ontology improvement service/system (with a Web application and/or Web services) that can allow ontologists to view logs and/or statistics and/or loop that back into the ontology improvement process. This may be tied to an ontology management tool via Web services. An ontology research and/or development team that can own the statistical analysis of search logs, ontology semi-automation, and/or *distributed* ontology development tools. The ontology tools has collaboration functions and/or to be tied into online communities and/or Wikis. Customers may be able to recommend ontology improvements from the Librarian and/or Web UI and/or have that propagated to the ontology analysis and/or development team in real-time.

Deny potential Denial-of-Service Attack when range: tag is used

In one embodiment, the KIS can not go beyond 1000 numbers in the range tag to guard against a DOS attack. This number may be adjusted as may be necessary.

In one embodiment, Deep Info Hyperlinks may be a visual tool in the Information Nervous System, used to complement the Deep Info pane. Deep Info Hyperlinks allow the user of the semantic client to navigate Deep Info not unlike navigating hyperlinks. This allows the user to be able to continuously navigate the semantic knowledge space, via Dynamic Linking, without any limitations based on the size of the knowledge space (which could exceed the amount of available UI real estate in say, a tree view). There may be a Deep Info stack to track “Back,” “Forward” and/or “Home”. For non-root category nodes in Deep Info, there may be an enabled “Up” button to allow the user to navigate to the parent category in a given ontology.

In one embodiment, Deep Info results (actual documents, people, etc.) can be restricted to the first major level in the tree (i.e., a result does not have a tree expansion which then shows more results—in the same in-place tree UI). Context templates (special agents or knowledge requests) can be displayed, along with previews of results there from, but thereafter the user can navigate to the template itself (e.g., Breaking News) to get more information—e.g., discovered categories with the template/special-agent as a pivot. Category hierarchies can be reflected in the tree as deep as may be needed. The user can navigate to a result, category, etc. and/or then continue the navigation from there—without overloading the UI.

FIG. 14 below illustrates this, in one embodiment of the invention. Deep Info Hyperlinks may be indicated with the underlined text. Also, notice the Back, Forward, Stop, Refresh, Home, Mail, and/or Print buttons (no different from a hypertext web browser). The user may be able to navigate the Deep Info knowledge space (via Dynamic Linking) by recursively clicking on the Deep Info Hyperlinks and/or by going “Back” and/or “Forward,” as desired. Clicking Home would take the user back to the starting “Deep Info position” (either for application-wide or profile-wide Deep Info or to the context point from where the Deep Info semantic chain was launched). Clicking Refresh would refresh the Deep Info pane, not unlike refreshing a loaded web page in a Web browser. Clicking Stop would stop the pane from loading. Clicking Mail would email the Deep Info XML contents to a person or group of persons. Clicking Print would print the Deep Info pane.

In one embodiment, the Deep Info Hyperlinks also have a drop-down menu to allow the user launch a new request (or entity) corresponding to the clicked Deep Info node.

Furthermore, in one embodiment, each entry in the Deep Info Hypertext space may be a legitimate launch point for a new request, bookmark, or entity. The user may be able to create a new request, bookmark, or entity (opened in place or “explored”—opened in a new window). The system intelligently maps the current node to a request, bookmark, or entity, based on the semantics of the node. For instance, a category may be mapped to a Dossier on that category (by default and/or exposed in the UI as a verb/command) or a “topic” entity referring to the category (as another option, also exposed in the UI as a verb/command). A context template (special agent or knowledge request) can be mapped to a request with the same semantics and/or with the filter based on the source node (upstream) in the Deep Info pane. Some nodes might not be “mappable” (e.g., a category folder) and/or the UI indicates this by disabling or graying out the request launch commands in such cases.

In one embodiment, the clipboard launch point for Deep Info can be automatically updated when the clipboard changes (via a timer or a notification mechanism for tracking clipboard changes) or can be left as is (until the user refreshes the Deep Info Pane). In one embodiment, the semantic client keeps track of the most recent N clipboard items (via the equivalent of a clipbook) and/or have those exposed in the Deep Info pane. The most recent clipboard item may be displayed first (at the top). The “current” item then may be auto-refreshed in real-time, as the clipboard contents change. Also, if the current item on the clipboard (or any entry in the clipbook) may be a file-folder, the Deep Info pane allows the user to navigate to the contents of that folder (shallowly or deeply, depending on the user's preference).

In one embodiment, there may be at least two Deep Info Panes with Hypertext Bars—a main pane that would encapsulate the entire semantic namespace and/or which may be displayed everywhere in the namespace (in every namespace item console) and/or a floating pane (the Deep Info Minibar) which may be displayed next to a selected result item. the main pane allows the user to semantically explore all profiles but the current (contextual) profile may be displayed first (highest in the tree, in the case of a tree UI, perhaps after the current request and/or clipboard contents Deep Info launch points). The Deep Info Minibar may be displayed when the user selects an item (perhaps via a small button the user must click first) and/or has only the result item as an initial launch point (so as not to overload the UI). Also, the Deep Info Minibar includes a Deep Info path with “Annotations” off the result item itself (in addition to all the context templates and/or other Deep Info paths). The Minibar also allows the user to explore—off the result item as a launch point—both the current (contextual) profile and/or other profiles in the system. The user is able to semantically explore Deep Info across profile boundaries.

[+] Current Request (Dossier on “*:Cardiac Failure”)

[+] MeSH

[+] Cardiovascular Diseases

[+] Cardiac Failure

[+] Clipboard Contents (Presentation: Life Sciences Market Forecast

2005-2010.ppt)

[+] MeSH

[+] Catabolism

[+] Protein Catabolism

[+] All Profiles

[+] My Profile

[+] Recommended Categories

[+] Cancer

[+] Amino Acids

[+] Breaking News

[+] Headlines

[+] Newsmakers
[+] All Bets
[+] Best Bets
[+] Experts
[+] Conversations

[+] Mary Smith

[+] Headlines

[+] Joe Johnson

[+] Interest Group
...

...

[+] Breaking News

[+] Headlines

[+] Newsmakers
[+] Best Bets
[+] Conversations

[+] Peter Marshal
[+] Kenneth Falk
...

...

[+] Categories in the News

[+] MeSH

[+] Cardiovascular Diseases

[+] Cardiac Failure
...

[+] Popular Categories
[+] Best Bet Categories
[+] My Categories
...

...
Legend:
• Blue: Ontology (Category Folder) for discovered category
• Red: Parent category for discovered category
• Green: Discovered category

In one embodiment, the Deep Info pane flags each category in the hierarchy as belonging to Best Bets, Recommendations, or All Bets. This allows the user to visually get a sense of the strength of the Deep Info path (in this case a category) IN THE CONTEXT of the strength of the categories IN THE CONTEXT of the query or document (or the Deep Info source). This may become a hint to the user per how much time and/or effort to spend navigating different paths. So in the example below, the user can have a clear sense that Cardiac Failure may be a Best Bet category, Dementia may be a Recommended category, and/or that Immunologic Assays may be an All Bets category. Also, there may be a visual indicator showing if a category is [also] in the news (e.g. Dementia below)—the sample picture shown reads “NEW!” but in practice reads “NEWS.” There may be also an indicator alongside each category folder showing the total category count, and/or the count for Best Bet, Recommended, and/or “In the News” categories. This provides the user with a visual hint as to the richness of the category results within a specific category folder (ontology) before he/she actually explores the category folder.

In one embodiment, in the case where a semantic wildcard query (or a category query) may be the Deep Info source, the hints represent the relevance of the inferred categories in the corpus itself. Else, in the case of a document, the clipboard, text, etc., the hints represent the INTERSECTION of relevance of the inferred categories in the source AND the corpus (the index). As an illustration, if the Deep Info source may be a document, the Best Bet hint for a Deep Info category may only be set IF the category (or categories) may be Best Bets in BOTH the source document AND the corpus. Ditto for Recommended categories (the category has to be at least a Recommendation in both source and/or destination). Else, the hint may be indicated as All Bets.

It guides the user to kpreferablythe relevance of the categories ALONG the path, consistent with BOTH source and/or destination. If the category may be weak in the source yet strong in the corpus, the intersection can tell the user same. If the category may be strong in both, this may be clearly the path to navigate first.

Here is an example, in accordance with an embodiment of the invention (see the legend below):

[+] Current Request (Dossier on “*:Cardiac Failure” AND

“*:Dementia” AND “*:Immunologic Assays”)

[+] MeSH (15 total, 1 Best Bet, 4 Recommended, 2 in the
News)

[+] Cardiovascular Diseases

[+] Cardiac Failure

[+] Mental Disorders

[+] Dementia

[+] Immunologic Techniques

[+] Immunologic Assays

Legend:
• Blue: Ontology (Category Folder) for discovered category
• Red (Bold): Parent category for discovered Best Bets (very strong

relevance) category

• Green (Bold): Discovered Best Bets category
• Red: Parent category for discovered Recommended (strong

relevance) category

• Green: Discovered Recommended category
• Dark Grey: Parent category for discovered All Bets (weak

relevance) category

• Light Grey: Discovered All Bets (weak relevance) category

In one embodiment, the model (as described above per flagging categories in context via visual hints) also applies to People. Experts may be to be treated as Best Bets on the People axis, Interest Group may be treated as Recommendations on the People axis, and/or Newsmakers may be treated as Headlines on the People axis.

In one embodiment, for a Person object in the Deep Info pane, the same model applies. However, the visual hints preferably would indicate relevance based on Expertise, Interest, and/or News (per newsmakers). These visual hints for discovered categories may be displayed IN ADDITION to the context templates (special agents or knowledge requests) also displayed for the Person/People in question. In the preferred embodiment, the symmetric (People) visual hints also supplement the Information hints (Best Bets, etc.). The visual hints may be based on direct equivalents in the semantic networks in the KISes in the contextual profile—indeed the Category information returned in the Deep Info query has identical attributes to the BestBetHint, RecommendationHint, BreakingNewsHint, and/or HeadlinesHint in the semantic network. These attributes indicate whether the category is a Best Bet category, a Recommended category, a Breaking News category, or a Headlines category. In one embodiment, the KIS goes further and/or also return a hint to the semantic client indicating whether the Deep Info source (e.g., John Smith) below is a “Best Bet” (expert per semantic symmetry), “Recommendation” (interest group per semantic symmetry), Breaking News (breaking newsmaker per semantic symmetry) and/or Headlines (newsmaker per semantic symmetry). The KIS accomplishes this by querying for these hints from categories in the Objects table (or Categories table in an alternate embodiment) and/or joining this against the People table with the filter indicating whether the person (“John Smith” in this case) has a semantic link to the category.

An illustration of the People visual hints is shown below, in accordance with an embodiment of the invention. The balloon tool tips show additional Deep Info visual hint qualifiers on the People axis, specifically related to the Person in question (in this case, John Smith).

[+] John Smith

[+] MeSH (15 total, 1 Best Bet, 4 Recommended, 2 in the News,

1 Expert, 2 Interest Group, 1 Newsmaker)

[+] Cardiovascular Diseases
[+] Cardiac Failure
[+] Mental Disorders

[+] Dementia

[+] Immunologic Techniques

[+] Immunologic Assays

In one embodiment, In Deep Info, as illustrated in the figure above, the user often starts from a category and/or then navigates from there. However, this can be problematic because the category' might not be “understood” (i.e., the category's ontology might not be supported) in other Knowledge Communities in the contextual profile. Semantic wildcards get around this because the interpretation of the context may be performed on the fly—the categories may be inferred in real-time and/or not explicitly specified.

In one embodiment, in Deep Info, it may be preferable to preserve the seamlessness of the user experience by supporting intelligent and/or dynamic navigation. With documents and/or text (and in some cases, entities), this happens automatically—Dynamic Linking already involves real-time inference and/or mapping of categories. However, with categories as the source context, things get a bit trickier for the reason described above. To address this, the Information Nervous System supports Intelligent Dynamic Linking If the source category is not understood (as explicitly specified), the KIS can indicate this in the Deep Info result set. However, the KIS can go a step further: it can then attempt to map the explicit category to semantic wildcards simply by adding the ‘*:’ prefix to the category name (off the category path). It can then rerun the Deep Info query and/or then return the result set for the new query to the semantic client. The new result set may be tagged as having been dynamically mapped to semantic wildcards. The semantic client can then display a very subtle hint to the user that the Deep Info results were inferred on the fly by the system. Some users might not care, especially if the category name is strong and/or distinct enough to communicate semantics regardless of the contextual path and/or the ontology. Some users, however, might care, especially if the explicit source category is unique and/or distinct from other contexts that might share the same category name.

In one embodiment, Dynamic Deep Info Seeking allows the user to seek to Deep Info from any piece of text. First, the user may be able to hover over any highlighted text (with semantic highlighting) and/or then dynamically use the highlighted text as context for Deep Info—the semantic client can detect that the text underneath the cursor is highlighted and/or then use the text as context. The result may be selected (if not already) and/or the Deep Info mini-bar invoked with the highlighted text as context (with semantic wildcards added as a prefix—for intelligent processing). This creates a user experience that feels as though the user seeks (without navigating) from a highlighted term to Deep Info on that term.

In one embodiment, this feature may be also extended to hovering over any piece of selected text. The user can select the text, hover over it, and/or then seek to Deep Info using the text as context.

In one embodiment, anywhere people may be exposed in Deep Info (including in the Deep Info mini-bar), Presence information may be integrated as an additional hint. This indicates whether a displayed user is online, offline, busy, etc. The Presence information may be integrated using an operating system (or otherwise integrated) API. Verbs may be also be integrated in the Deep Info UI to allow the user to see a displayed user and/or then open an IM message, send email, or perform some other Presence-related action either directly within the Deep Info UI or via an externally launched Presence-based or IM application.

In one embodiment, the Geography ontology allows semantic regional scoping/searching. This allows queries like Dossier on American Politics from General News. This may be invoked as Dossier on *:American *:Politics. Other examples may be:

1. Dossier on Investments in Asia □ Dossier on *:Asia *:Investments

2. Dossier on Caribbean or African Vacatio□ Dossier on *:Vacations AND (*:African OR *:Caribbean)

In one embodiment, we have an Institutions ontology that has every company name, school name, etc. We can use the Hoover's database as an initial reference. This can then be added to all General KCs.

In one embodiment, a combination of the following ontologies: General Reference, Products & Services, Geography, and/or Institutions provide very rich semantic coverage.

1.) The “Make me an ontology” Red Button

In one embodiment, this button can allow a Martian who just landed on Earth to create the first pass for an ontology describing previously unknown knowledge domains on Mars. Coming back to Earth, it would allow Nervana to generate a new ontology for domains or sub-domains, perhaps new industries like nanotech, etc.

In one embodiment, the scientific and/or product development part of this involves creating the Red Button to CONSTANTLY scan through documents on the Web and/or other sources and/or generate the ontology based on high-level taxonomic and/or conceptual inferences that can be made. The generated ontology may only be a first pass; humans may have to then follow up to refine the ontology.

2.) The “Does this ontology suck?” Red Button

In one embodiment, this button can allow a user to quickly determine the quality of an ontology. For all our current ontologies, what is the grade? Which gets an A? And which gets an F? Which ontology is so bad that it shouldn't be used in production, period? And why? What is the basis for determining A, B, C, D, E, or F? What is the scale and/or how are grades determined? These grades can then be used for our ontology certification and/or logo program. This can be employed for ontology comparison analysis (A.) are two ontologies semantically similar and if so, how much? B.) is ontology A better than ontology B for knowledge domain K and if so, by how much, and why?). This button may be tied into a real-time ontology monitor This monitor can constantly track search logs and/or web logs to determine if an existing ontology may be getting stale or may be otherwise not representative of the domain of knowledge it represents. Search lingo changes and/or the vocabulary around a knowledge domain changes; the real-time ontology monitor can make the “Does this ontology suck?” red button also a “Does this ontology still not suck anymore?” button.

3.) The “Fix this ontology” Red Button

In one embodiment, similar to the “Make me an ontology” red button, this button can allow a user to take an existing ontology, integrate it with the real-time ontology monitor, and/or have recommendations made on how to fix or improve the ontology.

1. In one embodiment, the KIS understands the following qualifiers:
author: (this restricts the search to the author field)
publisher: (or pub:) this restricts the search to the publisher field
language: (or lang:) this restricts the search to the language field
host: (or site:)—this restricts the search to the host/site from where the item originated
filetype:—this restricts the search to the file extension (e.g., filetype:pdf)
title:—this restricts the search to the title field
body: this restricts the search to the body field
pubdate:—the publication date
pubyear:—the publication year
range:—a number range (format □ range:<start>-<end>).
affiliation:—the affiliation of the author(s) (e.g., Merck, Pfizer, Cetek, University of Washington)

In one embodiment, you can combine these filters at will. The model may be also completely extensible—more filters can be added in a backwards compatible way without affecting the system.

E.g., Dossier on Heart Diseases AND lang:eng AND “author:long bh”—find all English publications on Heart Diseases authored by Long BH.

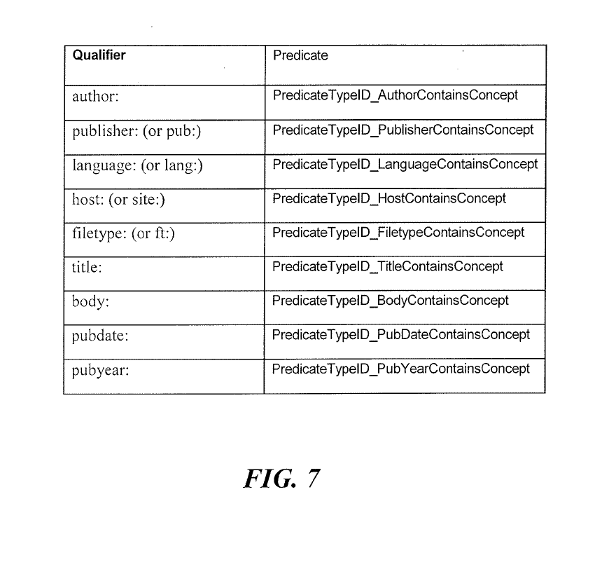

In one embodiment, each qualifier has a corresponding predicate which indicates the basis for the semantic link, linking a document (or other information item) to the concept in question. FIG. 7 illustrates the mapping of the qualifiers to predicates (the actual predicate values may be arbitrary but must be unique).

In one embodiment, semantic wildcards (and/or dynamic linking in general) defer semantic interpretation until run-time (when the query is getting executed). In contrast, a category reference (Uri) has a hard-coded expression for semantic interpretation. Hard-coded category references have the problem of brittleness, especially in the context of ontology versioning. A category path or URI might become invalid if an ontology's hierarchy fundamentally changes. This could become a versioning nightmare. With semantic wildcards (or drag and drop), on the other hand, there may be no hard-coded path or URI (the wildcards refer to concepts/terms that can be interpreted across ontologies and/or ontology versions). This is very powerful because it means that an ontology can evolve without breaking existing queries. It is also powerful in that it more seamlessly allows for ontology federation—with different ontologies in a virtual network of Knowledge Communities (KCs)—each wildcard term may be interpreted locally with the results then federated broadly.

In one embodiment, events awareness refers to a feature of the Information Nervous System where the system understands the semantics of events (end-to-end) and/or applies special treatment to provide event-oriented scenarios.

1. In one embodiment, there may be Events Knowledge Communities—for instance, Life Sciences Events. This may be similar to Web KC offerings like Life Sciences Market Research and/or Life Sciences Business Web, Life Sciences Academic Web, and/or Life Sciences Government Web.

Life Sciences Events can allow knowledge-workers semantically keep track of research conferences, marketing conferences, meetings, workshops, seminars, webinars, etc. For instance, questions like: Find me all research conferences on Gastrointestinal Diseases holding in the US or Europe in the next 6 months.

In one embodiment, the query above can involve the Geography ontology (as described above) to allow location-based filters that may be semantically interpreted.

In one embodiment, this Knowledge Community (KC) can be seeded manually and/or then filled out with additional business-development (as needed). The seeding would RSS integration (where available) and/or editorial tools (screen-scraping) to generate Event metadata (as RSS) which can then be indexed on a constant basis.

In one embodiment, a special RSS tag indicates to the KIS that an event “expires” at a certain date/time and/or after a certain time-span. When the event “expires” in the KC, the KIS automatically removes it.

This idea is also useful with e-Commerce KCs—imagine a semantic index of Sales Events—where a sale might “expire” and/or become unavailable to users of the index.

2. In one embodiment, The semantic client may be “aware” of results that may be events and/or can allow users to add events to their Outlook Calendar (or an equivalent). This can be done via a Verb/Task on a selected “event result.”

3. In one embodiment, the WebUI client allows users set reminders for events. The WebUI then emails them just before the event occurs (with a configurable window, not unlike Outlook). So for example, a user may be able to register for reminders (semantic reminders, if you will) for the sample query I indicated below.

4. In one embodiment, the KIS supports self-aware, expiring events, as described above.

5. In one embodiment, the KIS and/or the semantic clients also support a new field qualifier, location:, that allows the user to specify the desired location of an Events semantic search. This maps to a new predicate, PredicateTypeID_LocationContainsConcept. Also, there may be a startdate:, enddate:, and/or duration: (event duration) qualifiers with corresponding predicates.

In one embodiment, Drag and Drop dynamic query generation applies to entities, semantic wildcards, smart copy and paste and/or other Dynamic Linking invocation models. As noted previously, the query generation rules can result in sequential queries.

In one embodiment, when there are multiple SQML filter entries that may require dynamic semantic interpretation and/or query generation, the resultant query can be very complicated. For performance reasons, the following query reduction/simplification rules may be employed, in accordance with one embodiment of the invention:

1. If there is only one SQML filter entry, the previously described rules may be employed.

2. If there are multiple SQML filter entries and/or the operator is an OR, the previously described rules may be employed. The resultant queries may be then concatenated into a master sequential query set. This overall query set may be then invoked, with eventual result duplicates elided.

3. If there are multiple SQML filter entries and/or the operator is an AND, the resultant-query generation rules may be a bit more complicated. If there are multiple Best Bet categories generated from the source (the “dragged” object), the categories may be added to a resultant list. Else, if there is one Best Bet category, the category may be added along with Recommendations categories (if available). Else the Recommendations categories may be added to the resultant list (if available). Else, the All Bets categories may be added (if available). If there are non-semantic entries (as previously described)—for instance key concepts in the title or body—these may be also added to the resultant list. This may be repeated for all SQML filter entries. The resultant categories may be then added to one master semantic query, which may be then invoked with an AND operator.

4. If there are multiple SQML filter entries and/or the operator is an AND NOT, the rules described for AND (above) may be generated and/or then the resultant query may be modified to have an AND NOT operator rather than an AND operator.

These steps may be altered or changed as may be necessary.

In one embodiment, there are multiple semantic clients that access services exposed by the Information Nervous System. In one embodiment, this may be done via an XML Web services interface. There may be two additional semantic clients: the Nervana WebUI and/or the Nervana RSS interfaces.

These have several strategic benefits:

1. Low Total Cost of Ownership (no client install)

2. No/minimal training for massive deployments (familiar, Web-based interface)

3. Client flexibility (rich (Librarian) vs. reach (WebUI)); shows programmatic flexibility (system can be programmed/accesses with different clients)

4. Migration path (can start with WebUI; and/or then migrate to Librarian for power-user scenarios)

In one embodiment, the RSS interface may be also exposed via [HTTP] and/or can be consumed by standard RSS readers. Currently, the RSS interface emits RSS 2.0 data.

In one embodiment, the figure below shows an illustration of the WebUI. Notice the command-line interface with semantic wildcards—this provides a lot of the semantic power via a text box. Also, notice the integration of the Dossier Knowledge Requests to provide different contextual views of results.

In one embodiment, any WebUI query can be saved as an RSS query which emits RSS 2.0. This can then be consumed in a standard RSS reader. The RSS interface automatically creates a channel name as follows: Nervana <Knowledge Request> on <Filter>, where <Knowledge Request> is the knowledge request type (Breaking News, Best Bets, etc.), and/or filter is the search filter.

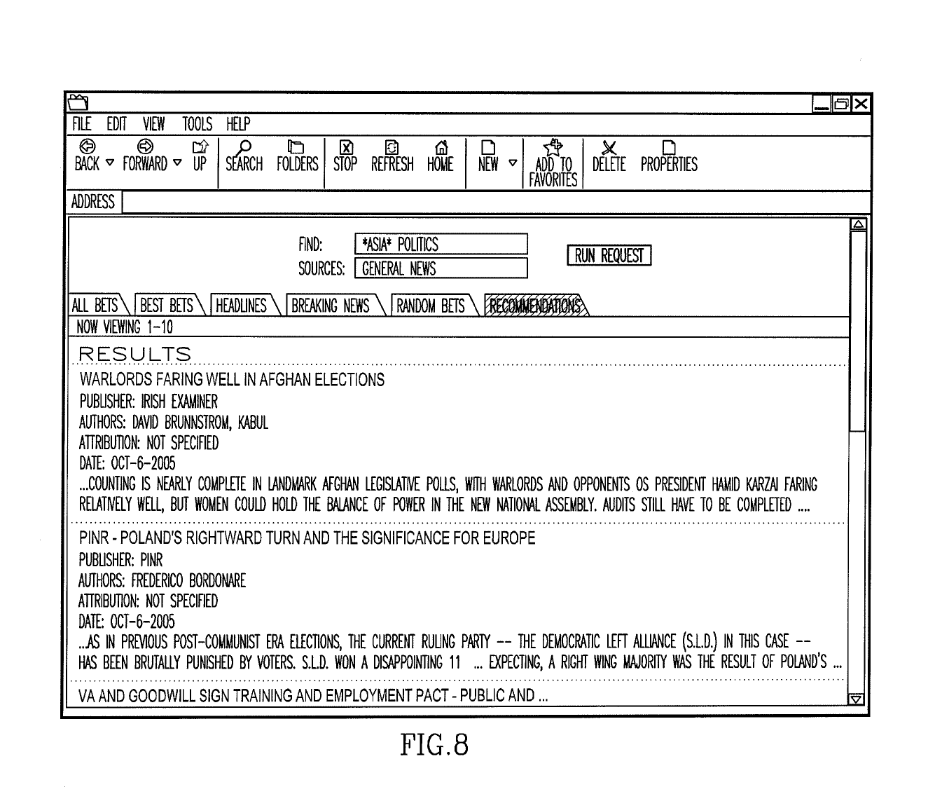

FIG. 8 illustrates a WebUI interface, in accordance with an embodiment of the invention.

In one embodiment, the Infotype semantic search qualifier may be a powerful and/or special qualifier that may be used to specify information types in the Information Nervous System. The user can ask for Breaking News but only those that may be Presentations. This may be specified as Breaking News on InfoType:Presentations.

In one embodiment, the KIS adds special info predicates corresponding to each information type. This can be a abstraction on top of filetypes—both predicate classes may be added to the semantic network. Furthermore, some infotypes yield other infotypes—e.g., a presentation may be also a document; in such cases, multiple predicate assignments may be issued. Because the infotype predicates may be in the semantic network, they can be mixed and/or matched with other predicate qualifiers, knowledge types, etc. For instance, a user can ask for Best Bets on InfoType:Spreadsheets AND “author:John Smith” (find me best bets that are spreadsheets authored by John Smith).

Here is a sample list of InfoType predicates:

PredicateTypeID_InfoType_Presentation

PredicateTypeID_InfoType_Spreadsheet

PredicateTypeID_InfoType_GeneralDocument

PredicateTypeID_InfoType_Annotation

PredicateTypeID_InfoType_AnnotatedItem

PredicateTypeID_InfoType_Event

In one embodiment, semantic type semantic search qualifiers may be like infotype qualifiers except that the qualifier tags themselves indicate the semantic type. This makes it clear to the KIS that only a specific predicate based on entity-detection is employed. For instance, “person:john smith” indicates to the KIS that only a concept that has been detected to refer to a person may be included in the semantic search. Or place:houston indicates only a place called Houston and/or not a name called Houston. And so on. This information may be added to the semantic network by the KIS via semantic type predicates. Examples may be:

PredicateTypeID_SemanticType_Person

PredicateTypeID_SemanticType_Place

PredicateTypeID_SemanticType_Thing

PredicateTypeID_SemanticType_Event

In one embodiment, time search qualifiers are pre-defined and/or semantically interpreted qualifiers that refer to absolute or relative time. These don't have to be (nor are they—in the case of relative times) hard-coded into an ontology—they can be interpreted in real-time by the KIS. The KIS then maps these qualifiers to an absolute time (or time range) IN REAL-TIME (resulting in a live computation of the actual time value) and/or then uses the resultant value in the semantic query.

### Examples

1. “pubdate:last week”

2. pubdate:today

3. “pubyear:this year”

4. “pubyear:last decade” (may be dynamically mapped to a range: query)

5. “startdate:next week” (for events)

6. “duration:two weeks”

Examples of queries that may be enabled by time search qualifiers are:

1. Find all events on mathematical models for climate change holding in California next week: All Bets on “*: mathematical models” AND “*:climate change” AND location:California and “startdate:next three months” (Notice that this query also includes the Geography ontology (for the California filter).

2. Find all presentations for request for proposals for communications equipment in the next quarter: All Bets on infotype:presentations AND “*:communications equipment” AND “*:next quarter”

In one embodiment, time ontologies allow the semantic interpretation and/or inference of time-related concepts. Examples of time-related concepts may be: “twentieth century,” “the nineties,” “summer,” “winter,” “first quarter,” “weekend” (terms for Saturday and/or Sunday), “weekdays” (have terms for Monday through Friday), etc.

This can allow queries like:

1. Find all sales presentations for deals that closed in the third-quarter: All Bets on *:sales AND infotype:presentations AND “*:third quarter”

2. Find research on quantum physics done by Nobel Prize winners in the second half of the twentieth century: Recommendations on “*:quantum physics” AND *:nobel prize” AND “*second half of the twentieth century”

In one embodiment, the triangulation of Time ontologies with Geography ontologies (as described above) covers the space-time continuum, which is part of reality.

In one embodiment, a similar model may be also applied for numbers—Number Ontologies. This enables queries with concepts like “six-figures,” “in the millions,” etc. This may be also be implemented with number search qualifiers.

In one embodiment, historical ontologies may be like Time ontologies but rather focus on time in the context of specific historical concepts. Examples:

1. Ancient China (concepts that describe all the places and/or other entities in Ancient China)

2. Pre-colonial Africa

3. Renaissance

In one embodiment, institutional ontologies may be used as a generic ontologies (like Geography). These have businesses, universities, government institutions, financial institutions, etc. AND their relationships.

Sample queries:
Find Breaking News on cancer research but only that done by Big Pharma
Find research on bacteria being done by any company affiliated with Merck (research partners, acquired companies, etc.)
Find Breaking News on job openings in technology companies but only those on the Fortune 500
Find great papers on Gallium Arsenide based semiconductor research but only by accredited European institutions

### Another Example

Find great articles on the possible use of semantics to improve research productivity in Life Sciences but only published by Industry Leaders

This involves the notion of “institutional people” (thought leaders, executives, influentials, key analysts, etc.), in all humility, which may be semantically correlated with an Institutions ontology.

In one embodiment, this ontology may be also useful to semantically search for companies and/or other institutions referred to by acronyms (e.g., GE). Also, this ontology handles common typos. Example: “Bristol-Myers Squibb” (correct spelling) vs. “Bristol Myers-Squibb” (very common typo).

In one embodiment, this ontology may be critical for IP searching, for which the ownership of IP is very important.

In one embodiment, a query like: {Find all patents on manufacturing techniques for polymer-based composites owned by DuPont} brings back patents by DuPont AND companies that have been *acquired* by DuPont—since DuPont will preferably own the IP.

In one embodiment, Commentary and/or Conversations may be treated differently in terms of their semantic ranking and/or filtering algorithms. This may be because they may be based on publications, annotations, etc. from people in the Knowledge Communities (KCs). The involvement of people may be a critical axis that determines the basis for relevance. For example, take an email message with the body “Sounds good.” or even something as short as “OK.” In a typical knowledge community using only ontology-based semantic indexing, ranking, and/or filtering, these messages might be interpreted as being irrelevant or weakly relevant. However, if the author of the email message is the CEO of the company (and/or the knowledge community corresponds to that company) or if the author is a Nobel Prize Winner, all of a sudden the email message “takes on” a different look or feel. It all of a sudden “feels” relevant, independent of the length of the text or the semantic density of the words in the text.

In one embodiment, another way to think of this may be that in knowledge communities, the author or annotator of an information item might contribute more to its “relevance” than the content of the item itself. As such, it may be dangerous merely to use ontologies as a source of relevance in this context.

In one embodiment, the Dynamic Linking model of the Information Nervous System partially addresses this because the user can navigate using different semantic paths to reach the eventual item—the paths then become a legitimate basis for relevance, in addition to—or regardless of—the semantic contents of the item itself.

In one embodiment, several changes may be made to the KIS indexing algorithms when indexing commentary or conversations, for example:

1. The semantic threshold may be set to zero—all items may be indexed

2. The ranking may be biased in favor of time and/or not semantic relevance (not unlike email)

3. An alternative to a formal Commentary context template (knowledge request) may be to have All Bets ranked by time and/or not semantic relevance—only, perhaps, for a specially defined and/or configured “Discussions” knowledge community (that may be treated differently)

In one embodiment, a model for comparing and/or mapping ontologies may be present. The model described here will generate a map that shows how several (2 or more) ontologies may be similar (or not). Given N ontologies O1 through ON, create N semantic indexes (using the Information Nervous System) of a large number of documents (relevant to a reasonable superset of the knowledge domains that correspond to the ontologies) using each ontology. For every category in each ontology and/or for each document in the corpus, generate a table that with columns for Best Bets and/or Recommendations. These columns will indicate the semantic strength of the category in the given document.

In one embodiment, once these tables may be generated, a separate set of steps may be invoked to map categories across the ontologies, for example:

1. For every source category that may be a Best Bet, find every category in every other ontology that may be a Best Bet. Assign a high score (e.g., 10) for this mapping. For parents of the target categories, assign a high but lesser score (e.g., 8). An additional scalar factor (weakening the score) can be applied for broader categories (moving up the hierarchy chain).

2. For every source category that may be a Recommendation but may be not also a Best Bet, find every category in every other ontology that may be either a Recommendation or a Best Bet. Assign a median score (e.g., 6) for the former (Recommendation) mapping and/or a slightly higher score (e.g., 8) for the latter (Best Bet mapping). For parents of the target categories, assign a high but lesser score (e.g., 4 and 6, respectively). An additional scalar factor (weakening the score) can be applied for broader categories (moving up the hierarchy chain).

3. For every source category that may be an All Bet but may be neither also a Recommendation nor a Best Bet, find every category in every other ontology that may be an All Bet, a Recommendation, or a Best Bet. Assign a median score (e.g., 2, 4, and 6, respectively) for these mappings. For parents of the latter categories, assign a high but lesser score (e.g., 1, 2, and 3, respectively). An additional scalar factor (weakening the score) can be applied for broader categories (moving up the hierarchy chain).

4. Categories that don't qualify based on the above rules may be assigned a score of 0.

In one embodiment, all the scores may be tallied. For every category, a ranked list of every category in every other ontology may be generated (from highest to lowest scores, greater than 0). This then represents the ontology assignment/comparison map. The larger and/or more relevant the corpus to the entire ontology set, the better. This map may be then be used to map categories across ontology boundaries—during indexing.

In one embodiment, federated and/or merged semantic notifications refers to a feature of the Information Nervous System that allows users to have rich semantic notifications from a federation of knowledge communities, organized by profile, and/or across a distributed set of servers.

In one embodiment, every KIS can be configured with a master notification server that it then communicates notifications too (based on a polling frequency and/or on registered user semantic-requests). Federated identity and/or authentication may be used to integrate user identities. The master notification servers then merge all the notification results, elide duplicates, and/or then notify the registered user.

Alternatively, the user can register for notifications from specific KISes (and KCs) which can then notify the users (via email, SMS, etc.).

Alternatively yet, these notifications can be sent to a Notification Merge Agent which lives centrally on a special KIS. This merge agent can then mark all the source profiles (by GUID), merge and/or organize the notification results by profile, and/or then forward the merged and/or organized results to the registered user.

In one embodiment, this refers to a feature to allow the user to get semantic wildcard equivalents from the semantic client categories dialog. The categories dialog can have a “Copy to Clipboard” button-enabled only, perhaps, when there may be selected categories. When this button is clicked, the selected categories may be copied to the clipboard as text.

### Example

If “Heart Diseases” and/or “Muscular Diseases” are selected as categories, the following may be copied to the clipboard as text:

‘*:Heart Diseases” OR “*:Muscular Diseases”

In one embodiment, the user can then go back to the edit control in the standard request or the command line on the Home Page and/or click Paste. The user can then change the text to AND, add parentheses, change the wildcard to a specific ontology alias qualifier (e.g., Cancer or MeSH), etc.

In one embodiment, this may be the semantic client namespace item serialization model and/or file formats—for Request, Results, and/or Profiles (and/or other non-container namespace items) Saving and/or Sharing (e.g., email):

In one embodiment, a request may be saved (or emailed) as a Zipped folder (read: an easily sharable file). When we have critical mass, we can have our own extension (.req) which we actually reserved a couple of years ago.

In one embodiment, the Zipped folder can contain the following files and/or folders:

In one embodiment, results (this folder can contain the results as they were when they were saved):

[Request Name].XML (the results as RSS)
If the request is a Dossier, there may be one XML file for each request type

[Request Name].HTM (the results saved as an HTML file)

If the request is a Dossier, there may be one HTML file for each request type

The HTML file may be a report generated from the results XML. It can have lists and/or a table showing each result and/or it metadata. Also (from a usability standpoint), it can have hyperlinks to the result pages, which a TXT file would not have.

In one embodiment, request (Original Profile) (this folder can contain the XML (SQML) that represents the semantic query/request AS IT WAS WHEN IT WAS SAVED)
[Request Name].XML

The request XML can contain all the state in the original request, including the KCs for the request profile. This allows other users to view the identical request, since their profile information might be different.

Request Info.HTM (this file can describe the request, its filters and/or the original profile, including the names of its KCs and/or category folders)

This file can also contain the metadata for the request—e.g., the creation date/time, the last modified date/time, the request type, the profile name, etc.

In one embodiment, request (Any Profile) (this folder can contain the XML (SQML) that represents the semantic query/request WITHOUT ANY PROFILE INFORMATION)

[The request XML can contain all the state in the original request, but only, perhaps, with the request filters, excluding the KCs for the request profile. This allows other users to view the request in their own profiles, if the filters are what they find interesting]
Request Info.HTM (this file can describe the request and/or its filters)

This file can also contain the metadata for the request—e.g., the creation date/time, the last modified date/time, the request type, etc.

In one embodiment, Readme.HTM
This file can describe the contents of the folder

This file can also contain the metadata for the request—e.g., the creation date/time, the last modified date/time, the request type, etc.

NOTE: In one embodiment, the Zipped folder name can be prefixed with “Nervana.”

Example: Nervana Dossier on Cell Cycle AND Protein Folding.ZIP

In one embodiment, a similar model may be employed for serializing profiles—profiles contain folders with each request, in addition to the profile settings.

Why the ZIP Format?

1. Allows seamless pass through thorough most email systems that screen out unknown or suspicious file types (this precludes us from having a custom file type until post critical mass)

2. One file makes for ease of sharing, saving, and/or management

3. Internal folder structure allows for rich metadata display with multiple views of the request state (in files and/or sub-folders)

4. Zip is an open format with broad industry support. Zip management may be preferably built into Windows XP allowing for easy management of the saved request and/or results. Furthermore, there may be many third-party Zip SDKs for customers that might want to generate reports from saves Nervana requests/results. For example, a customer might want to write an application that scans through file or Web folders containing saved Nervana requests/results, extracts the contents from the Zip folders, and/or then manipulates, analyzes, aggregates, or otherwise manages the saved RSS results within each zipped folder. So a customer (say, Zymogenetics) can have an application that monitors a shared folder, opens the zipped Nervana folders, and/or then aggregates the RSS results (from different requests) to, say, database tables or spreadsheets for analysis.

5. Compression: Because many of the elements in the saves folder is in the XML format, Zip can result in a very high (and/or significant) compression ratio (up to 10:1 from published studies/reports and also from my experience).

6. Malleability and Extensibility: Zip can provide backward and/or forward compatibility for the “format.” Old versions of the Librarian may be able to “open” requests from future versions and/or vice-versa. Zip would also allow us (in large measure) to add and/or remove components from the “format” without affecting the core of the “format.”

In one embodiment, Newsmakers refers to authors of inferred news (within one or more agencies or knowledge communities) in a given context. Newsmakers may be “known” (provable identities) within a user's knowledge communities. Newsmakers may be members of agencies (knowledge communities) so a user can continue to navigate with a newsmaker as the virtual pivot object—a user can find a Newsmaker, navigate to Headlines by that Newsmaker, drag and drop one of those Headlines to find semantically relevant Best Bets, navigate to the Interest Group for one of those Best Bets, etc.

In an alternative embodiment, Newsmakers can also be people featured in the news—the system maps extracted concepts, performs entity detection to detect names, and/or attempts to authenticate those names against names in the agency. The system can then assign a similar (but not identical) Newsmaker predicate that indicates that the semantic link has uncertainty (e.g., PREDICATETYPEID_MIGHTBENEWSMAKERON). The “Newsmaker” context template query can then include this predicate as part of the Newsmaker query—but in some cases, the predicate can also be excluded (this model preserves flexibility). In the preferred embodiment, the authors may be authenticated by their email address so this problem wouldn't Occur.

In one embodiment, Newsmakers may be authenticated authors (and/or members of the agency (knowledge community)). A separate “In the News” query can be generated for entities (including unauthenticated people) that may be featured in the news.

In one embodiment, RSS Commands/Verbs may be special signals embedded in RSS that direct the KIS to take actions on specific information items. These may be specified with namespace-qualified elements that correspond to specific verbs that the KIS invokes.

### Examples

1. meta:insert or meta:add (instructs the KIS to index the RSS item)

2. meta:delete or meta:remove (instructs the KIS to delete the RSS item)

3. meta:update (instructs the KIS to update the RSS item)

Let n be the total number of keywords that are semantically relevant to all the filters in the query. And let k be the number of semantic or keyword filters in the query.

In the general case, the order of magnitude of total number of combinations may be by which the n items can be arranged in sets of k may be represented by the formula:

$${}_{}^{n}{C}{}_{𝓀}^{} = 𝓀 ! , where \text{:} {P}_{k} = \frac{n !}{( n - 𝓀 ) !}$$

Also, note that in this case, we use combinations and not permutations because the order of selection for semantic queries does not matter (A AND B=B AND A).

For union (OR) queries, this count may be accurate. For intersection (AND) queries, and/or if there are multiple filters, the exact count may be less than this (although of the same order of magnitude) because exclusions must be made for the keyword combinations within the same category filter.

Example: Take the semantic query: Find all chemical leads on bone diseases which are available for licensing.

This can be expressed in Nervana as: All Bets on Bone Diseases (MeSH) AND

### Chemical (CRISP)

In the text-box interface, this can also be expressed as a search for “MeSH:Bone Diseases” AND CRISP:Chemical. Alternatively, this can be expressed as a cross-ontology

Search for “*:Bone Diseases” AND *:Chemical but we can focus on the ontology-specific searches here in order to simplify the analysis.

Bone Diseases (MeSH) currently has a total of 308 keywords representing the many types of bone diseases and/or their synonyms and/or word variants. Chemical (CRISP) has a total of 5740 keywords representing the very many number of chemical compounds and/or their synonyms and/or word variants.

Adding the keyword ‘licensing,’ this amounts to a total of 6049 keywords.

Assuming 2 keywords per search, and/or plugging this into the equation above, this can result in the following:

$${P}_{𝓀} = \frac{6049 !}{( 6049 - 2 ) != 6049 * 6048 = 36584352}$$

Therefore, ⁿCₖ=36584352/2!=18292176

In other words, it can take approximately 18.3 million 2-keyword searches to approximate the semantic query represented above (even discounting semantic ranking, filtering, and/or merging). And because these are 2-keyword queries, the quality of the search results (even in the non-semantic domain) can suffer greatly.

Assuming 3 keywords per search, and/or plugging this into the equation above, this can result in the following:

$${P}_{𝓀} = \frac{6049 !}{( 6049 - 3 ) != 6049 * 6048 * 6047 = 221225576544}$$

Therefore, ⁿCₖ=221225576544/3!=36870929424

In other words, it can take approximately 36.9 billion 3-keyword searches to approximate the semantic query represented above (even discounting semantic ranking, filtering, and/or merging). Adding a third keyword would likely improve the quality of the search results (even in the non-semantic domain). But this results in an even more exponential explosion in the number of keyword searches necessary to fully exhaust all the possibilities encapsulated in the semantic query.

4-keyword searches can result in an astronomical number of searches.

And so on.

Additional Combinatorial Explosions

And then multiply this by the different kinds of queries (like Breaking News, etc.). So if the researcher wants the results grouped in, say 6 contexts, the total may be 6 times the number of keyword queries shown above. And then multiply this by the different silos of knowledge over which the researcher must repetitively search. This represents the total astronomical number of searches required to approximate a federated Nervana Dossier.

Matters are made worse yet as the queries get more complex. For instance, if the query was: Find all chemical leads applicable to both Bone and Heart Diseases and which are available for licensing, this would correspond to a Dossier on Bone Diseases (MeSH) AND Heart Diseases (MeSH) AND Chemical (CRISP) and ‘licensing’. The combinations can explode to an even more astronomical number because the value n above would be much higher due to the number of keywords that represent all the types of Heart Diseases.

In one embodiment, to efficiently index real-time newsfeeds, a staging server hosts a daemon which downloads news items and/or then indexes them in an intermediate staging index. This index may be then divided up into multiple channels—allowing for indexing scale-out (with each KIS indexing one channel). More channels can then be added to provide more parallelism and/or less simultaneous read-write (while indexing)—in order to improve both query and/or indexing performance.

Examples of channels may be: LifeSciences, GeneralReference, and InformationTechnology.

Examples of corresponding URLs may be:

Life Sciences: [http]://Caviar/NDC_SQL/DefaultPage.aspx?channel=lifesciences

General Reference: [http]://Caviar/NDC_SQL/DefaultPage.aspx?channel=generalreference

Information Technology: [http]://Caviar/NDC_SQL/DefaultPage.aspx?channel=informationtechnology

In one embodiment, the connector's ASP.NET page takes an additional parameter Since, also case-insensitive. The format of time may be yyyy-mm-ddTHH:mm:ss. For example: 2005-06-29T16:35:43. This can be easily obtained in C# by calling date.ToString(“s”), where date may be an instance of System.DateTime structure. The paging parameters may be as earlier: Start and PageSize.

In one embodiment, the connector emits RSS 2.0 data which may be mapped from the staging index (with the news items). The RSS 2.0 data indicates that the data may be from a Nervana Data Connector. There may be also a paramsSupported field which indicates to the KIS which parameters the connector supports. Once the KIS downloads the RSS, it parses it. It then checks to see if the RSS is from a Nervana Data Connector. If it is, it then checks the paramsSupported field. If this is populated, it then checks if the “since” parameter is one of the comma-delimited items in the field. If the “since” parameter is found, the KIS then makes note of the current time. It continues to index the RSS and/or page through until it reaches the end of the RSS stream. At that time, and/or when the KIS starts re-indexing (the next time), it adds the since parameter to the connector URL query string with the time indicated above (the time since when the “last” indexing round began). This may be akin to the KIS asking the connector for only those data items that it (the staging index) has added “since” the last indexing round. This is a very efficient way to incrementally index news in real-time—it ensures that only new items are indexed without the I/O overhead of a full incremental index.

Here is a snippet from an RSS 2.0 item generated from a News connector:

<?xml version=“1.0” encoding=“utf-8” ?>
- <rss version=“2.0” xmlns:dc=“[http]://purl.org/dc/elements/1.1/”

xmlns:meta=“[http]://schemas.nervana.com/xmlns/rss_2_0_meta.html”>

-<channel>

<title>GeneralReference2</title>
<category>Nervana Data Connectors</category>
<generator>Nervana Data Connector for SQL</generator>

<meta:paramsSupported>Channel,Start,PageSize,Since,FilterNDays,Order</me

ta:paramsSupported>

<meta:startIndex>0</meta:startIndex>
<meta:endIndex>999</meta:endIndex>
<language>en-us</language>

-<item>

<meta:robots>nofollow</meta:robots>
<dc:language>English</dc:language>
<title>Oxford student murdered in ‘honour killing’</title>
<pubDate>10/6/2005 11:43:00 PM</pubDate>
<author/>
<dc:publisher>The Tribune</dc:publisher>
<description />

<link>[http]://c.moreover.com/click/here.pl?z402461455&z=700238245</link>

<guid isPermaLink=“false”>402461455</guid>
</item>

FIG. 7: News connector RSS item snippet

The nofollow meta tag may be added accordingly, based on whether the link is accessible or not.

In one embodiment, the Nervana Knowledge Center may be a Federated universe of Nervana-powered content, providing the transformation of Information to Knowledge. The Knowledge Center has semantically indexed content, People (in a future version), and/or annotations (also in a future version). In various embodiments of the invention, any of the following may be included:

1. Smart News (General News and Domain-Specific News

2. Smart patents (General patents and Domain-Specific patents)

3. Smart Blogs (merely a semantic index of blogs).

4. Smart Marketplace: This may be the e-commerce scenario and/or includes sponsored listings that may be semantically indexed. The KCs therein may be first-class KCs (with people, annotations, etc.). I contend that if there is enough value in the content and/or the medium, people can independently subscribe (the one person's ad is another person's content scenario I described recently). Examples include:
Products
Jobs (postings and/or resumes)

5. Nervana-Run Research KCs (e.g., Semantic/Smart Medline).

6. Nervana-Run Domain and Scenario-Specific KCs: Examples include Compliance, Sarbanes-Oxley, etc.

7. Smart Web (domain-specific):
Business Web
Academic Web
Government Web

8. Smart Libraries: This may be where we partner with content providers like Science Direct, Elsevierat least who have been looking for premium revenue channels for many years. There may be two possible models here. In one model, they provide abstracts and/or maybe full-text to us since we drive revenue to them via smarter discovery. We can host the KCs and/or own/manage the initial consumer relationship. In another model, they can host KCs themselves and/or pay us licensing fees for our technology.

NOTE: Smart Libraries preferably can have ALL the tools in the toolbox. They may be first-class Knowledge Communities, they can have people, they can have annotations, etc. See more below.

9. Smart Groups: Smart Groups may be like a semantic (knowledge-oriented) equivalent of blogs. The scenarios here are numerous. There may be many thousands of knowledge communities around the world—on everything from gene research to fly-fishing. Users can first sign up (maybe for $5 a month) as members of the Nervana Network. As a member, you may be then able to create and/or moderate Smart Groups. Smart Groups may be different from regular groups (like Yahoo Groups) or blogs in that:
They may be semantically and/or context-aware. Knowledge types like Interest Group, Experts, Newsmakers, Conversations, Annotations, Annotated Items, provide semantic access to community publications and/or annotations.
Semantic threads a Conversations become first-class semantic objects that can be returned, ranked, and/or navigated.
The Knowledge Toolbox: All the tools in our toolbox a Breaking News, Live Mode, Deep Info, etc. can be applied to Smart Groups. These tools do not apply to regular (information) groups on the Web.
Semantic navigation (Deep Info): Emphasis is due here. Smart Groups can be semantically navigated via Deep Info. The semantic paths may be at the knowledge level.
Dynamic Linking: Users may be able to navigate from their desktop to Smart Groups, to say, Newsmakers within those Groups, to the annotations by those Newsmakers, and/or then to relevant knowledge IN DIFFERENT KNOWLEDGE COMMUNITIES—all at the speed of thought.
Awareness: Live Mode and the Watch List display Newsmakers. Newsmakers may be actionable—so a user can see Newsmakers and/or immediately start to navigate/explore.
Federation: Client and server-side

Examples of Smart Groups: Research communities, virtual communities across companies (including partners, suppliers, etc.), classes in schools (e.g. working on specific projects), informal communities of interest around specific area, etc. Imagine a group of researchers that may be able to annotate results from Nervana Semantic Medline (after a Drag and Drop) in their own Smart Groups, and/or create semantic threads based on results from Medline, and/or then annotate Smart News results around those semantic threads.

10. Smart Books: in partnership with a large aggregator like Barnes & Noble. Subscribe to a Nervana Smart Books KC and/or semantically finds books with semantic wildcards and/or the like. Dynamically link that to Smart Groups within (Smart Books a moderated by Nervana) OR your own Smart Groups (moderated by you or a friend/colleague).

11. Smart Images: in partnership with a large aggregator like Getty or Corbis. Semantically find professional or amateur photographs by dragging and/or dropping a picture from your desktop. And then creating semantic threads around the pictures you find—with other hobbyists that like photography as much as you do (in your Pictures-based Smart Groups). The provider may be responsible for providing rich annotations to the books.

12. Smart Media (Music and Video): in partnership with large music and/or video (including live broadcast) aggregators. The key value proposition here may be that reviews become semantic and/or context-aware. Communities of interest may be formed around music genres, movies, etc. This needs to be more tightly moderated because it may be more consumer-oriented. Preferably ALL the tools in the toolbox can apply.

In one embodiment, live mode may be a Watch List of one and/or may be aimed at providing awareness-oriented presentation for a specific request (including special requests and/or Dossiers) or request collection. It allows users to track timely results in the context of a request or request collection.

In one embodiment, the Presenter periodically issues queries to the KISes in the contextual profile for a request in Live Mode. A request can be in normal mode or live mode. The Presenter also sorts the results based on timeliness and/or provides additional functionality for handling News Dossiers (previously described) and/or for guarding against KC starvation in the case of federated profiles.

In one embodiment, the Presenter can have a configurable refresh rate and/or other awareness parameters. On the UI side, the skin polls the Presenter for results. The Presenter polls the KISes and/or then places the results in a priority queue (as previously mentioned). The skin then picks up the results and/or shows special UI to indicate recently added results, freshness spikes, an erosion of freshness (fade), etc.

In one embodiment, the Presenter guards against KC starvation in federated profiles by making sure results from a high-traffic KC don't completely drown out results from lower-traffic KCs. The Presenter employs a round-robin algorithm to ensure this.

In one embodiment, the Live Mode skin can choose to display the metadata for the results in its own fashion. In addition, the skin can creatively display UI to indicate the relative freshness and/or “need for attention.” Attributes that can be modeled in the UI may be, in accordance with various embodiments of the invention:

1. Activity: This indicates the rate of change of results.

2. Freshness: This indicates how old an individual result may be. The skin can show UI for new results differently from old results (e.g., in brighter colors, bigger fonts, etc.)

3. Spike Alert: A Spike Alert may be generated/fired when a new result is the first fresh result over a given period of time. The Presenter sets a timer; if the timer expires with no results then a flag may be set. The very next “fresh” result would trigger a Spike Alert in the UI. The arrival of a new result resets the timer. The Spike Alert may be designed to draw the user's attention to a given result. The methods of drawing attention may include a small sound, a pop up alert window, a color change, or a movement of page elements.

In one embodiment, the semantic client and/or WebUI support the saving, exporting, and/or emailing of results. All results can be saved or exported or selected results can be.

In various embodiments of the invention, some of the following features may be present.

1. Only those results that have been cached—but NOT those on the screen. If the user clicks Next and/or then Previous, the cache expands and/or all the cached results may be selected.

2. For the WebUI, we save from the server-side cache. For the semantic client, the client-side cache. In one embodiment, there may be no need for any communication to the server for saving at the Librarian.

3. File formats: All Results Lists may be RSS (XML, cross-platform). Reports may be HTML (portability. cross-platform, no need for special clients, etc.). However, Dossiers may be saved in zipped folders. The folders can contain N+1 files (RSS and/or HTML, depending on the user's selection), where N is the number of open Dossier requests (<=6) and/or 1 represents the “All” list which may be a merged list of results (duplicated elided). Zipped folders provide a single thicket model (ease of sharing, ease of file management, etc.), they may be portable, cross-platform and/or pass though firewalls (most firewall extension filters allow zips to pass through)—for email sharing. All results may be prefixed with ‘Nervana’ (e.g., Nervana Breaking News on ‘*:cancer *:kinases’). The user can then rename the file/folder. The HTML reports may be also branded with our logo and/or tagline and/or the logo may include a hyperlink to our web site—for viral marketing.

4. In the preferred embodiment, we invoke a mailto: url with no recipient and/or then an auto-embedded attachment with the files/folders AND semantically relevant message title. The user is then to fill out the recipient, etc. In an alternative embodiment, there may be additional UI to provide forms—the user can do this in his/her email client. Email clients like Outlook have other features the user might want to use during the sending process (sending to an email list, validating the list, ccing to others, etc.)

In one embodiment, this infrastructure can then be used for semantic email alerts—in one embodiment, the user registers his/her email address(es) and/or semantic wildcard (or other) queries. The semantic client or WebUI can then email (or via some other notification channel) periodic breaking news or headlines results to the user. These may be in HTML and/or RSS, as described above.

In one embodiment, the Email Companion Agent may be an agent that employs the email notification infrastructure described above and/or may be a companion to an existing distribution list. So the admin can create a distribution list to track semantic topics and/or the companion agent can email breaking news and/or headlines to the list on a periodic basis, consistent with the semantics of the distribution list.

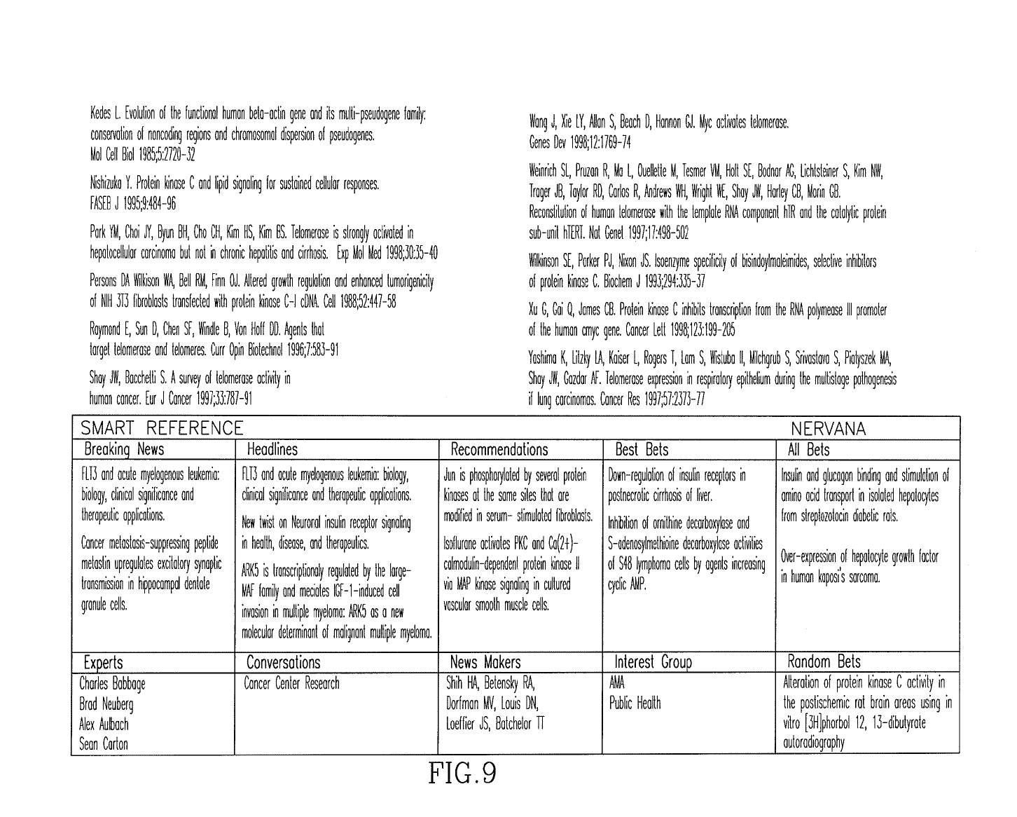

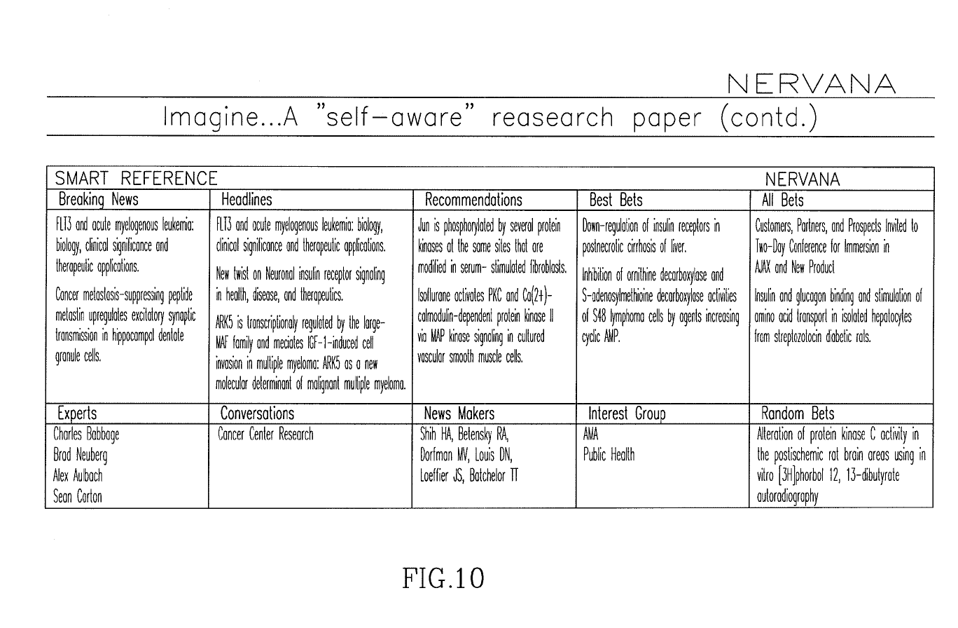

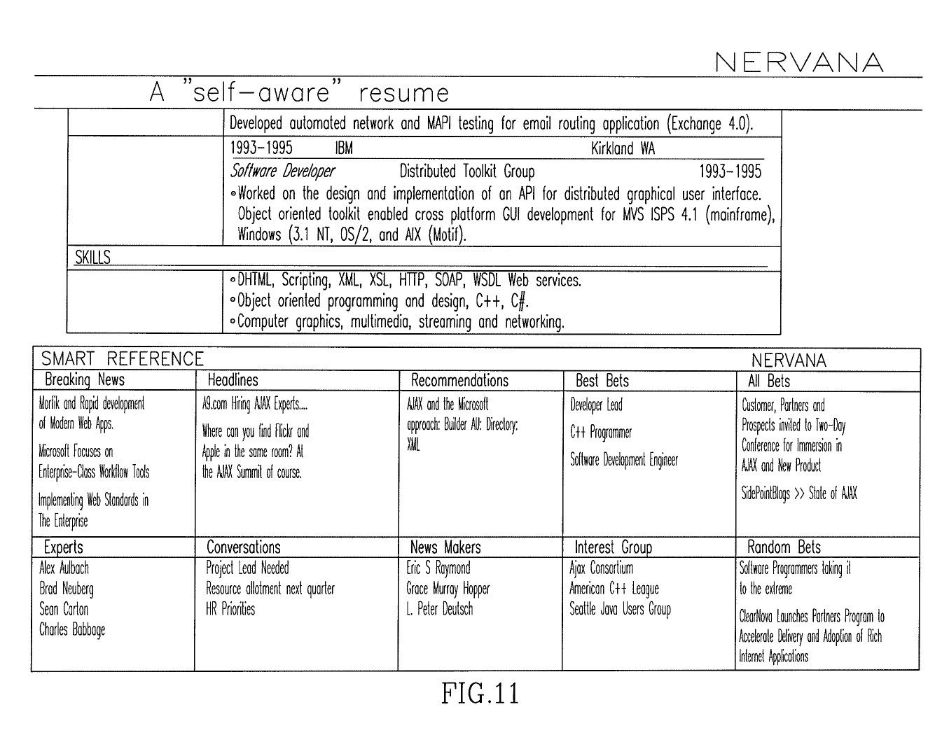

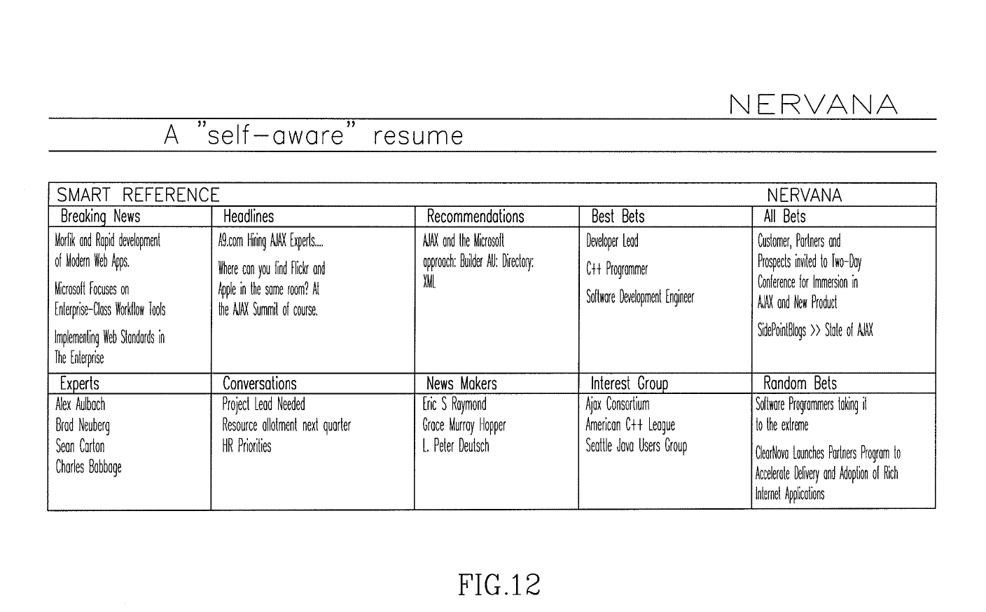

Referring generally to FIGS. 9-12, in one embodiment, self-aware documents may be documents—using the Information Nervous System—that generate their own live, semantic references. This employs the Dynamic Linking functionality of the Information Nervous System but embeds the logic in documents themselves (the document “drags and drops itself” in real-time). A document can be configured to dynamically link to one or more knowledge communities (federated). Imagine a self-aware research paper that generates its own references. The references are as good—in the general case, with arbitrary papers—as references the author generates him or herself. This passes the Turing Test ([http]://en.wikipedia.org/wiki/Turing_test) and/or may be a test for whether P=NP ([http]://www.claymath.org/millennium/P_vs_NP/).

In one embodiment, self-aware documents can “call” into the semantic client runtime to invoke Dynamic Linking in real-time—as they are displayed. Imagine a research paper emailed around with live, semantic references. This is extremely powerful because the value of the paper changes over time—as the surrounding “semantic environment” changes. The documents can be configured with authentication information that may be passed into the semantic client runtime. The argument to the Dynamic Linking APIs may be the “self” URI (the document itself).

In one embodiment, semantic profiles may be wrappers around entities, as described in a previous invention submission. For instance, a semantic profile can be built for a company (based on relevant documents, filed patents, etc.) And then semantic screening refers to tracking incoming and/or outgoing information (including documents) and/or correlating the information to one or more semantic profiles. For instance, a company might build semantic profiles for companies involved in ongoing patent litigation and/or then set up screening rules to ensure that no document leaves the company relevant to the litigation. Similar rules can be setup for incoming traffic.

Deploy Combinatorial Filters: Manage combinatorial complexity; Provide manageable, meaningful, probabilistic, ranked inputs into Disease Model; Inputs into a stochastic model; Deploy Early Warning Systems; Decision-Support; Diseases to target? Projects to keep? Licensing, M&A opportunities? Safety, IP issues? Signaling systems (biomarkers, toxicogenomics, etc.); Build Drug Discovery Libraries; Research, patents, safety studies, factoids, etc.; Enable Knowledge Feedback Loop.

Optimally must filter data inputs that are: Mostly unstructured text (85%); Physically fragmented; Semantically fragmented; e.g., phenotype data; Multidimensional; Full of Uncertainty, Context, and Ambiguity; Must understand and reason; Targets, phenotypes, etc. are semantic entities; NOT keywords; Provides meaning-based drug discovery and early-warning. Computers cannot reason without understanding.

Combinatorial Hypotheses: Examples include Drug Discovery: Find anticancer agents that induce apoptosis; Find small molecule drugs for spinal cord injury; Find chemicals that prevent the initial signaling and chemical reactions that turn on the immune system; Find chemicals that inhibit the migration of inflammatory cells to joint tissues; Safety: Find preclinical data for recently approved cancer drugs employing monoclonal antibodies.

Ontologies: Describe knowledge domains; Basis for semantic interpretation; Necessary but NOT sufficient; Needed: Ontologies+Combinatorial Filter; Filter: Handles combinatorial mathematics; Use ontologies as inputs; Avoid extremes of ontological simplicity & complexity; Simple enough but not too simple; “Semantic loss”; Complex enough but not too complex: “Semantic overkill”; Yet more mathematical complexity.

Why not keyword search? Does NOT address combinatorial complexity; Rather, it monetizes it (via advertising); No semantics=no discovery; Hypotheses are semantic! E.g., find chemicals that inhibit the migration of inflammatory cells to joint tissues; Keyword search results are a mirage; a very poor first-level approximation; “Lucky” results (OK for consumers, bad for research); “Objects are less relevant than they appear.”

Why not manual tagging? Scale; Humans cannot keep up with combinatorial explosion; Multi-dimensionality; Problems have multiple axes; Single-ontology tagging is insufficient; E.g., PubMed/MeSH; Context and ranking; Semantic evolution and unpredictability; Must separate content from semantic interpretation.

Why not federated keyword search? Makes a bad problem worse. Exposes MORE combinatorial complexity; Does not address semantic fragmentation; E.g., different expressions of phenotype data; Creates more problems than it solves.

The Semantic Web. W3C semantic integration effort; Good ontology standards (e.g., OWL); But . . . does not address unstructured data (85%); Ignores the hardest problems; Knowledge representation; Combinatorial ranking & filtering; and Reasoning under uncertainty & ambiguity.

Strategic Imperative: Refine your Business Processes. “Knowledge Audits”: Processes, Metrics and Accountability; Best Practices, Due Diligence: R&D; What is the history of similar efforts? What lessons have been learnt? Are we reinventing the wheel? Early Warning; Competitors, M&A, Licensing, Clinical Trials, Safety, IP, etc.; Collaboration is now mission-critical; Collective intelligence.

In one embodiment, Call to Action Phase I: Start with External Data; Deploy Combinatorial Filters; Deploy Early-Warning Systems; Use well-known ontologies; Start building Discovery Libraries; Corresponding to hypotheses; Across silos. Phase II: Refine your business processes; Processes, Metrics and Accountability; Design Knowledge Audits. Phase III: Unlock your internal data. Phase IV: Define your knowledge domains; Develop or license ontologies for your domains; Open Biological Ontologies; [http:]//obo.sourceforge.net/; National Center for Ontological Research (NCOR); [http://]ncor.us/; Gene ontologies, HUGO, UMLS, FMA, etc.; Phase V: Add a semantic (ontology-based) layer atop your silos; Phase VI: Complete semantic integration platform; Deploy and federate combinatorial filters; Conduct regular knowledge audits and enable a future of amazing possibilities. Imagine “Self-Aware Information” (documents, research papers and the like).

Decompress the R&D Bottleneck; Rising costs, lower productivity, expiring patents; Dire consequences; Proposed Drug Discovery Knowledge Architecture; Combinatorial Filters; Hypothesis validation; Orders of magnitude productivity improvements; Knowledge feedback loop; Discovery Libraries; Consistent with semantic hypotheses; Early Warning Systems; Mine your existing data; Refine your business processes; Enable a future of amazing scenarios; Science fact, not science fiction. All approaches at the linguistic layer have generally failed for the past 50 years. Problem reformulation: Natural Language Input expressed as a Directed Acyclic Graph (DAG)—G1. Indexed corpus stored using the identical representation—G2. The goal is to find the maximum common sub-graph isomorphism between G1 and G2.

G1 and G2 are potentially infinite. Infinite number of predicates and objects. Subject, Predicate, Object (SPO) Triple Model. Linguistic layer has infinite characteristics. Maximum Common Sub-graph Isomorphism (MCS) is NP-complete. Challenge is to solve an NP-complete problem in P. Problem statement: Find an algorithm in P (polynomial time) that solves the MCS problem. Query results=G3 which is isomorphic to G1 and G2 and is the maximum common sub-graph.

Client: Document/text extraction, Text compression and optional encryption; Server: Text categorization—using one or more ontologies, Naïve Bayes, SVM, LSI, Categories become objects with URIs, Build raw graph Gr1 with document/text as subjects and categories (ranked by semantic density) as objects; Graph reduction: Find Gr2 (a reduced representation of Gr1) that maintains the semantics of Gr1; Rank ranges (patent pending)—create new context predicates to build Gr2. Server: Graph collapsing, Remove semantic redundancies, Cross-ontology graph consolidation, Cluster categories that share the same semantics across ontology boundaries; Graph pruning, Prune Gr2 graph by histogram-based analysis of semantic density distribution to yield G1; Graph caching: Cache generated G1 graph using document/text hash as key into graph hash table, this way, rerun queries run much faster.

Prune graph cache using LRU algorithm, Server: Inexact graph matching: Map G1 to G2 (corpus) using ranked sequential queries (patent pending); Start from top edge and semantic intersect lower edges; Generate structured query: Use context predicate (e.g., Best Bets) to impose maximum commonality filter for sub-graph extraction (optimized for precision); Uses rank ranges to generate context predicates from raw predicates; Category as object (post ontology processing) means match is inexact; Inference engine has added new semantic links in corpus so match is inexact (optimized for recall). Stop at curve-knee of semantic distribution, if not enough edges, prune matching steps; If still not enough, fall back to non-semantic query; Repeat and stop at next higher edge; Synthesized results from each step and elide duplicates using hash table, Multi-graph matching (multi-drag and drop).

EXCLUSION (NOT): Merely exclude edges instead of a semantic intersect; e.g., find all patents on which this document does NOT infringe; INTERSECT: N input graphs Gi1, Gi2, . . . GiN; Apply algorithm for Gi1 through GiN; Join edges from each graph; Ignore non-overlapping steps; e.g., find all technical reports relevant to all 3 of these classic papers; UNION: N input graphs Gi1, Gi2, . . . GiN; Reorder steps for sequential queries, ranked; Round-robin; Apply algorithm for Gi1 through GiN; With new reordered steps; Explode sequential queries; e.g., find all technical reports relevant to any of these 3 classic papers; Optional steps: Forward chaining in order to increase recall; Use ontology hints to guarantee safe chaining; Hint-less forward chaining is dangerous and is not recommended; Graph partitioning for very long documents; Ideally, use NLP or document object model to intelligently detect partitions; Chapters, Sections, Pages, etc.; Partition G1 into Gp1 . . . Gpn; Perform inexact graph matching for each sub-graph; Synthesize the results: Practical solution for P vs. NP problem; One of 7 unsolved problems in Mathematics; Clay Mathematics Institute Millennium Problems; Should pass the Turing Test: Use Drag and Drop to generate references for a research paper. If committee of domain experts cant tell if the references were human (the author) or machine generated, then Nervana has passed the Turing Test. Algorithm has numerous applications: True semantic search & discovery, Image recognition, Cartographical analysis, Fingerprint detection, Protein folding, Cheminformatics and the like.

TalentEngine™. A critical and growing need in recruiting and staffing is that of sourcing and ranking the best and most qualified candidates to ensure the highest caliber work force to any organization. Nervana's TalentEngine™ is a powerful new software based business tool that provides HR managers the most cost effective means of managing critical staffing Discovery, Screening, and Ranking processes while significantly reducing costs typically incurred in identifying the best possible candidates from fragmented sources, domains, and databases.

This hosted “on-demand” service employs Nervana's award winning artificial intelligence engine to automatically source resumes and curriculum vitae from fragmented sources including the internet, job boards, social networks, proprietary databases, and any targeted domain, and to match them to relevant positions. Resulting matches are ranked using novel and proprietary algorithms with unparalleled efficiencies (employing over one hundred variables available). TalentEngine™ Services assist HR managers to increase placement quality while streamlining associated workflows.

With Nervana's natural-language-processing technology a custom job or target profile can be submitted as query and the TalentEngine™ aggregates ideal resumes, curriculum vitae, and user profiles from multiple open and accessible domains (delivering both active and passive candidates). The system then builds an intelligent semantic index based on domain-aware ontologies and numerous other variables (standard and custom) and performs automated screening and ranking based on semantics or meaning . . . not on keywords! This helps ensure that a candidate's skills are matched in only the most relevant context, and also helps address the now common and misleading practice of “keyword stuffing” where candidates often populate their resumes with keywords independent of their qualifications. The best matches are then periodically published, stored and made available to the user. This empowers users with a complete sole-source solution to effectively manage recruiting and staffing management of sales, administration, technologists, and engineering professionals.

TalentEngine™ provides a single platform tool that delivers its user the capability to leverage artificial intelligence to match criteria similar to human thought on a super computing scale, allowing HR Managers to focus on the most critical decisions and functions of HR processes. It guarantees human capable oversight (Quality Assurance and Control) across an expansive and fully automated set of Discovery, Screening, and Ranking processes that today can over stretch the precincts of limited HR resources.

ADVANTAGES include: Increase your Draw; Get the most out of your advertising and posting budget; No more “blasting”, No more missed prospects, Monitor multiple fragmented sourcing channels via an integrated platform, Increase your reach to the best qualified candidates, Discover the best qualified talent across multiple fragmented touch-points, Pushing vs. pulling, Reduce your Recruiting Costs: Drastically reduce labor costs by streamlining workflows and optimizing the use of human review, Get highly targeted, qualified candidates and minimize exposure to arduous “trial and error” keyword search, and resume-keyword-stuffing and other manipulation techniques, Shorten your Time-to-Hire; Substantially shorten the time to identify and recruit the best qualified candidates in an extremely competitive labor market; Use existing resumes, bios, or cover letters as natural-language queries to complement or accelerate the use of job descriptions and to bolster laser-like targeting, Automated Ranking and Bulls-Eye Scoring Techniques, Short list qualified candidate pools via statistical ranking by determining quantifiable variable summaries, Position & Industry specific custom or standard candidate scoring.

One embodiment of TALENTENGINE™ ARTIFICIAL INTELLIGENCE COMPONENTS may include Overall Candidate Relevance, Job Industry Relevance, Job Category Relevance, Job Experience Relevance, Job Skills Relevance, General Relevance, Red Flags, Custom Relevance(s).

### Pricing and Features Examples

1. Annual User Access License: $1000 per seat per year

2. Standard Edition: $500 per month per query

3. Professional Edition: $1000 per month per query

4. Premium Edition: $2000 per month per query

5. One embodiment of the Custom Edition may include: Premium Edition+$100 per custom variable per month.

Standard Edition may include, but is not limited to: Screening and Ranking (customer-provided resumes, referrals, and career web sites); Emailed Reports; RSS Feeds; Secure Report-Hosting Portal; Search within Reports; Report Diaries Professional Edition: Discovery, Screening, and Ranking. Web (resumes); Free Job Boards; Subscription Job Boards; Social Networks; Career Web Site; Referrals and Custom Databases; Premium Edition: Professional Edition plus: Nervana Resume Database; Relevant Blogs; Relevant News; Relevant Inventors; Relevant Scholars. Nervana TalentEngine™ provides HR Managers a paradigm shift to staffing workflow through the power of semantics and artificial intelligence.

While the preferred and/or some alternate embodiments of the invention have been illustrated and/or described, as noted above, many changes can be made without departing from the spirit and/or scope of the invention. Accordingly, the scope of the invention is not limited by the disclosure of the preferred embodiment. Instead, the invention should be determined entirely by reference to the claim that follows.

1. A computing system for knowledge retrieval, management, delivery and presentation, comprising:
a memory;
a knowledge integration service, stored in the memory and comprising a first set of searchable data that is semantically indexed; and
a user interface component stored in the memory that is configured to, when executed on a computer processor:
allow a user to transfer a digital representation of an entity from a first application to the user interface;
semantically ascertain one or more semantic properties of the transferred digital representation of the entity; and
index the ascertained one or more semantic properties of the transferred digital representation of the entity with the knowledge integration service.

2. A computing system comprising:
at least one server programmable to store at least one semantic relationship between entity information and at least one category and to access domain-specific data that is used to determine the at least one semantic relationship between the entity information and the at least one category,
wherein the at least one server is programmable to perform the steps of:
receiving entity information by enabling a user to provide the entity information to the at least one server by placing a graphical representation of the entity in a screen portion associated with a server user interface;
determining the at least one semantic relationship between the entity information and the at least one category using the domain-specific data;
storing the at least one semantic relationship between the entity information and the at least one category; and
delivering the entity information based on the at least one semantic relationship between the entity information and the at least one category.

3. A method for searching data products stored on a computer readable medium, implemented on at least one computer comprising:
building a natural language relationship of a plurality of data products forming a semantic linkage map, further comprising:
receiving an indication of an entity from a user interface, the user interface configured to receive the indication of the entity when a user provides the entity by placing a graphical representation of the entity in a screen portion associated with the user interface;
receiving contextual information related to the entity;
analyzing the text within the received entity and the received contextual information based on a series of predefined relationships to determine at least one semantic concept, the semantic concept built from analysis of the language, word patterns, and a context of the text within each data product, the semantic concept containing text not found within the data product but inferentially related by connection in the semantic linkage map;
creating semantic metadata using the determined semantic concepts;
determining associations between the semantic metadata in the plurality of data products;
applying a semantic ranking to the semantic metadata;
indexing the ranked semantic metadata;
linking the ranked semantic metadata to create a linkage map
receiving a search query of the built semantic linkage map further comprising:
analyzing the search query based on the series of predefined relationships to determine at least one semantic concept in the search query based on at least one of a meaning and a context, the semantic concept containing text not found within the data product but inferentially related by connection in the semantic linkage map;
creating semantic metadata using the determined concepts;
comparing the semantic metadata to the indexed and ranked semantic metadata; and
displaying a list of data products in a rank order based on the compared semantic metadata.
